(19) United States
(12) Patent Application Publication
(10) Pub. No.: US 2014/0056043 A1
(43) Pub. Date: Feb. 27, 2014

(54) POWER GENERATOR, AND ELECTRIC EQUIPMENT USING IT

(71) Applicant: Panasonic Corporation, Osaka (JP)

(72) Inventors: Yasuyuki Naito, Osaka (JP); Keiji Onishi, Osaka (JP)

(21) Appl. No.: 14/114,348

(22) PCT Filed: Feb. 26, 2013
(86) PCT No.: PCT/JP2013/001128

§ 371 Date: Oct. 28, 2013

(30) Foreign Application Priority Data
Mar. 16, 2012 (JP) 2012-060741
Mar. 16, 2012 (JP) 2012-060749
Mar. 16, 2012 (JP) 2012-060751

(51) Int. Cl. H02M 7/06; H02N 1/00

(52) U.S. Cl. CPC H02M 7/06; H02N 1/00
USPC 363/84

(57) ABSTRACT

A power generator includes a power generating device that generates a power by receiving vibration, and a power converter that converts the output of the power generating device. The power generating device outputs powers through a first system and a second system. The power converter is driven by receiving the output of the second system from the power generating device, and converts the output of the first system from the power generating device into another power.

### TECHNICAL FIELD

The technical field relates to a power generator for receiving vibration and generating a power and an electric equipment using it.

### BACKGROUND ART

Micro electro mechanical elements (MEMS elements, MEMS: Micro Electro Mechanical Systems) are applied to a lot of fields such as radio, light and acceleration sensors, biotechnologies and power generation. As devices in which an MEMS technology is applied to the field of power generation, environment power generating devices (energy harvesters) that collect light, heat and vibration energies scattering in an environment and utilize them are being developed. The environment power generating devices are applied to, for example, power supplies of low-power radios to implement wireless sensor networks or the like that do not require power cables or batteries. Further, when the MEMS technology is applied to the environment power generating devices, the environment power generating devices are expected to be miniaturized.

In an environment where light and thermal emission amounts are comparatively small, vibration-type power generating devices that utilize a force applied from an external environment to generate a power through vibration of members composing elements are useful. The vibration-type power generating devices include piezoelectric, electromagnetic and electrostatic power generating devices. Particularly electrostatic vibration-type power generating devices have the advantage of being able to be manufactured by a simple method without piezoelectric materials and magnetic materials.

Since such vibration-type power generating devices have very small generated power, power generators with higher generating efficiency are demanded. Techniques relating to this include, for example, a technique disclosed in Patent Document 1.

### PRIOR ART DOCUMENTS

### Patent Documents

Patent Document 1: JP 2010-246230 A

### SUMMARY OF INVENTION

### Problems to be Solved by the Invention

However, in the above type of power generators, their reliability and generating efficiency have room for improvement. Therefore, at least one of the reliability and the generating efficiency of the power generators is further improved so that power generators whose power generating quality is further improved are provided.

### Means for Solving the Problem

A first aspect of a power generator includes a power generating device that generates a power by receiving vibration, and a power converter (power management circuit) that converts an output of the power generating device. The power generating device outputs powers through a first system and a second system. The power converter is driven by receiving the output of the second system from the power generating device, and converts the output of the first system from the power generating device into another power.

A second aspect of a power generator includes a power generating device that generates a power by receiving vibration, and a power converter that converts the output from the power generating device. Presence/non-presence of power conversion in the power converter is switched based on the output from the power generating device.

### Effect of the Invention

In the power generators of the respective modes, at least one of the reliability and the generating efficiency is improved, so that power generators whose power generating quality is improved are provided.

### BRIEF DESCRIPTION OF DRAWINGS

FIG. 1 is a block diagram illustrating a power generator according to a first embodiment.

FIGS. 2A and 2B are cross-sectional views of a power generating device according to the first embodiment.

FIG. 3 is a diagram describing a relationship between arrangement of electrodes in the power generating device and a vibratory direction of a movable electrode.

FIGS. 4A to 4D are diagrams describing a relationship between vibrations of a movable substrate of the power generating device and power generation of the power generating device

FIG. 5 is a block diagram illustrating a power generator according to a second embodiment.

FIG. 6 is a block diagram illustrating a power generator according to a third embodiment.

FIG. 7 is a top view of a passive switch.

FIG. 8 is a cross-sectional view of the passive switch along the line A-A′ in FIG. 7.

FIG. 9 is a top view of another passive switch.

FIG. 10 is a cross-sectional view of the another passive switch along the line A-A′ in FIG. 9.

FIG. 11 is a block diagram illustrating a power generator according to a fourth embodiment.

FIGS. 12A and 12B are cross-sectional views of a power generating device according to the fourth embodiment.

FIG. 13 is a block diagram illustrating a power generator according to a fifth embodiment.

FIG. 14 is a block diagram illustrating a power generator according to a sixth embodiment.

FIGS. 15A and 15B are cross-sectional views of a power generating device according to the sixth embodiment.

FIGS. 16A to 16D are diagrams describing a relationship between vibrations of a movable substrate of the power generating device and power generation of the power generating device

FIG. 17 is a block diagram illustrating a power generator according to a seventh embodiment.

FIGS. 18A and 18B are cross-sectional views of a power generating device according to the seventh embodiment.

FIG. 19 is a block diagram illustrating a power generator according to an eighth embodiment.

FIG. 20 is a block diagram illustrating a power generator according to a ninth embodiment.

FIG. 21 is a block diagram illustrating a power generator according to a tenth embodiment.

### MODE FOR CARRYING OUT THE INVENTION

Since a vibration-type power generating device generates a power using a vibration energy generated in an environment as an energy source, the output of vibration-type power generator is occasionally unstable, and thus the reliability of vibration-type power generator is occasionally deteriorated. For example, when vibration is too strong, extremely high-voltage caused by power generation might cause a trouble in power generator having the vibration-type power generating device. Further, when a vibration is too weak, power conversion efficiency is decreased, generated power of a power generating device occasionally falls below power consumption of the power generator, and thus power stored in a battery or the like at the subsequent stage of the power generator might be decreased. The following embodiments can provide the power generator in which at least one of the reliability and the generating efficiency is improved, and which can supply a power more stably and has an improved power generating quality.

The embodiments will be described below with reference to the accompanying drawings.

### 1. First Embodiment

### 1-1. Configuration

### 1-1-1. Entire Configuration

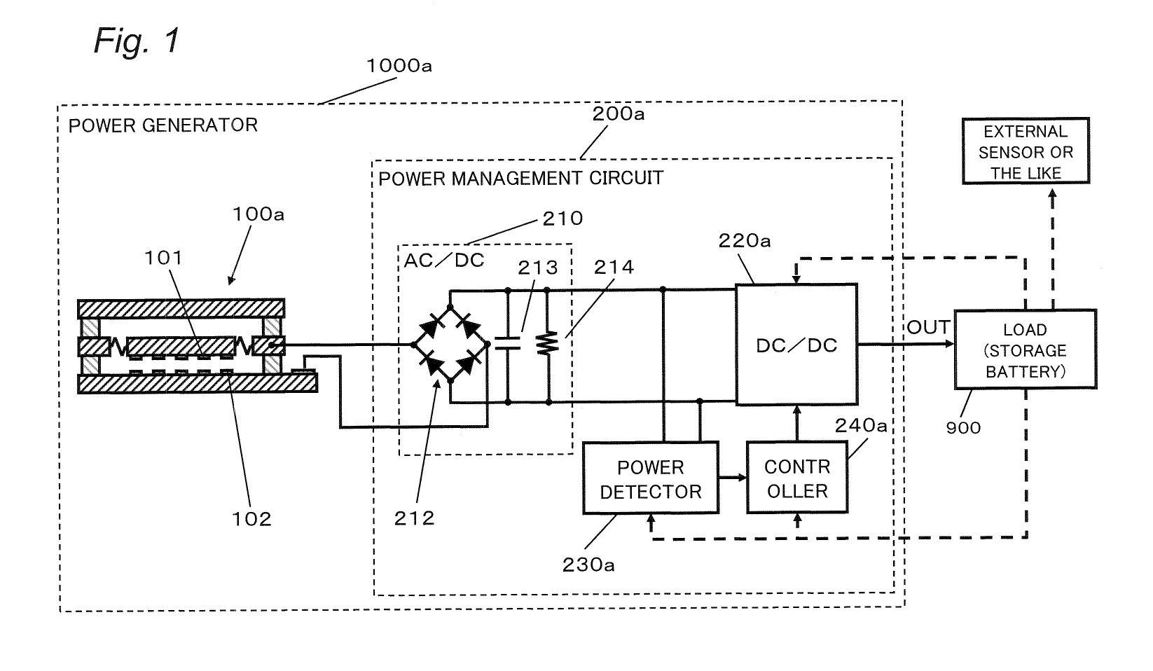

FIG. 1 is a block diagram illustrating the power generator according to the present embodiment. As shown in FIG. 1, a power generator 1000a according to the present embodiment includes a power generating device 100a and a power management circuit 200a. The power management circuit 200a is composed of an AC/DC converting circuit 210, a DC/DC converting circuit 220a, a power detector 230a, and a controller 240a. The power generating device 100a may be a vibration-type power generating device manufactured by, for example, an MEMS (micro electro mechanical elements) technique. The power generating device 100a includes an electret 101, an electrode 102, and so on. The AC/DC converting circuit 210 of the power management circuit 200a includes a smoothing circuit composed of a bridge rectifier circuit 212 composed of four diodes and a capacitor 213, and a load resistance 214.

The power generating device 100a is connected to the AC/DC converting circuit 210. The AC/DC converting circuit 210 is connected to the DC/DC converting circuit 220a. The power detector 230a is connected between the AC/DC converting circuit 210 and the DC/DC converting circuit 220a. The controller 240a is connected to the power detector 230a and the DC/DC converting circuit 220a. The DC/DC converting circuit 220a is connected to an external load (for example, storage battery) 900. Further, the storage battery 900 is connected to the DC/DC converting circuit 220a, the power detector 230a, the controller 240a, an external sensor (no reference symbol), and so on to be capable of supplying a power.

The power generating device 100a generates a power through an internal vibration due to an external force, and outputs an alternating current.

The AC/DC converting circuit 210 converts the alternating current (voltage) output from the power generating device 100a into a direct current (voltage).

The DC/DC converting circuit 220a converts a direct current voltage generated by a direct current output from the AC/DC converting circuit 210 into a direct current voltage of another voltage value. The DC/DC converting circuit 220a supplies a power to the storage battery 900 on the outside.

The power detector 230a detects the power of a direct current output from the AC/DC converting circuit 210.

The controller 240a stores a lower limit value of power. “The lower limit value of power” is a power value that is a standard for determining execution/stopping of the converting operation of the DC/DC converting circuit 220a.

The lower limit value of power may be set to be, for example, 1/10 of a maximum value of an input power to the DC/DC converting circuit 220 generated in normal power generation from the power generating device 100a. For example, when the maximum value of the normal input power to the DC/DC converting circuit 220 is 100 μW, the lower limit value of power is set to 10 μW. That is to say, the lower limit value of power is set to be the standard for stopping the converting operation of the DC/DC converting circuit 220a when the input power is lowered from 100 μW to 10 μW and power conversion efficiency is reduced from 85% to 70%.

Alternatively, the lower limit value of power may be also set to the input power to the DC/DC converting circuit 220a at a time when an output power of the DC/DC converting circuit 220a and power consumption of the power management circuit 200a are assumed to be equal to each other.

The controller 240a switches the voltage converting operation of the DC/DC converting circuit 220a between execution and stopping based on a power value detected by the power detector 230a.

The storage battery 900 stores the power supplied by the DC/DC converting circuit 220a. The storage battery 900 supply a part of the stored power to the DC/DC converting circuit 220a, the power detector 230a, the controller 240a, external sensors, and so on, to bring these devices into an operable state. The DC/DC converting circuit 220a, the power detector 230a and the controller 240a may consume the power supplied from the storage battery 900 to operate.

### 1-1-2. Configuration of Power Generating Device

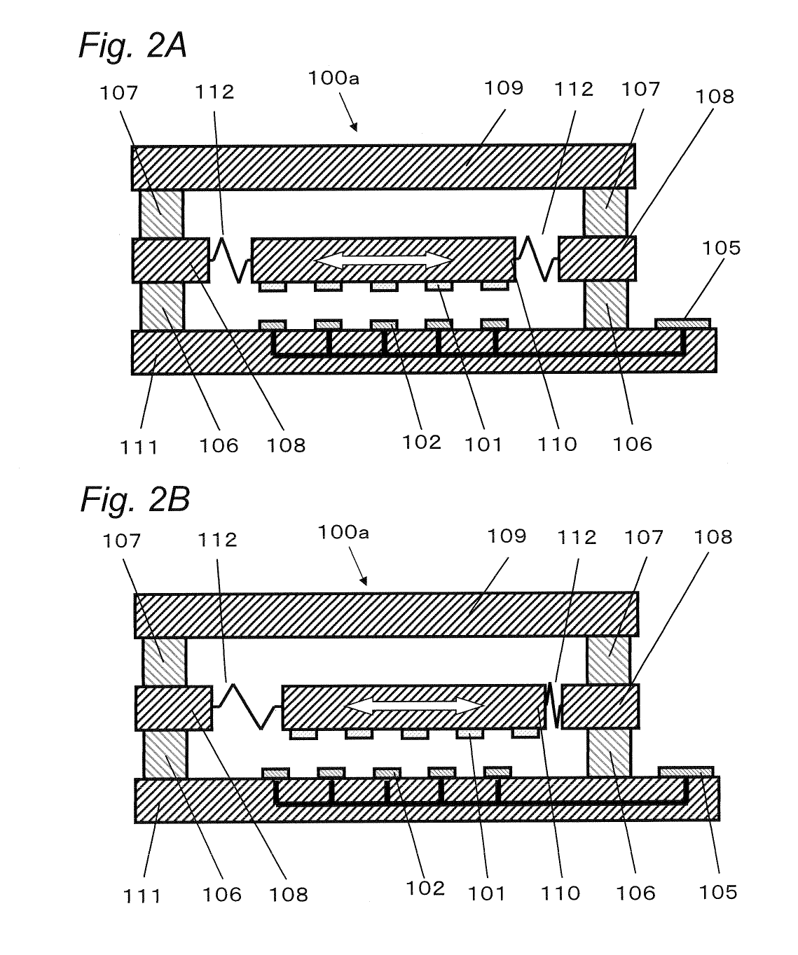

A configuration of the power generating device 100a will be described with reference to FIGS. 2A and 2B. As described later, the power generating device 100a includes a vibration body (a movable substrate 110) that vibrates inside. FIG. 2A illustrates a state that the movable substrate 110 is at the center of vibration. FIG. 2B illustrates that the movable substrate 110 is at the end of vibration.

The power generating device 100a includes a lower substrate (first substrate) 111, an upper substrate (a second substrate) 109, a movable substrate (movable section, weight, the vibration body) 110, springs (elastic structures) 112, fixed structures 108, upper joints 107, lower joints 106, the electrets 101, the electrodes 102, and a pad 105.

The upper substrate 109 and the lower substrate 111 are fixed by the upper joints 107 and the lower joints 106 to place a predetermined distance from the movable substrate 110, the springs 112 and the fixed structures (intermediate substrate) 108 and be opposed parallel to each other.

The fixed structures 108, the movable substrate 110 and the springs 112 are formed by, for example, machining one substrate. Therefore, the fixed structures 108, the movable substrate 110 and the springs 112 may be “the intermediate substrate 108 to which the movable substrate 110 is connected by the elastic structures 112” or “the intermediate substrate 108 which has the weight 110 movable by the elastic structures 112”.

The movable substrate 110 is composed to move to at least one axial direction (for example, a two-way arrow direction in FIGS. 2A and 2B) parallel with the upper substrate 109 or the lower substrate 111. Therefore, the movable substrate 110 can vibrate (reciprocation motion) to a direction parallel with the upper substrate 109 according to vibration applied externally as shown in FIG. 2B.

A surface of the upper substrate 109 opposed to the lower substrate 111 is a lower surface. A surface of the lower substrate 111 opposed to the upper substrate 109 is an upper surface. The upper surface of the lower substrate 111 and the lower surface of the upper substrate 109 correspond to a first substrate surface and a second substrate surface, respectively.

The upper surface of the lower substrate 111 is provided with a plurality of electrodes 102. Wiring for connecting the electrodes 102 is connected to the pad 105 through the lower substrate 111. The power generating device 100a outputs a generated electric current through the pad 105. Further, the surface of the movable substrate 110 opposed to the lower substrate 111 is provided with a plurality of the electrets 101. The electrets 101 are provided so that a line of electric force passing through the center of the electret 101 is vertical to the upper surface of the lower substrate 111. The line of electric force may direct from the movable substrate 110 to the lower substrate 111, or the direction may be reversed. Hereinafter, the line of electric force directs from the movable substrate 110 to the lower substrate 111.

The lower substrate 111 and the fixed structures 108 are jointed by the lower joints 106 so that a predetermined gap is provided between the electrodes 102 and the first electrets 101. Similarly, the upper substrate 109 and the fixed structures 108 are jointed by the upper joints 107.

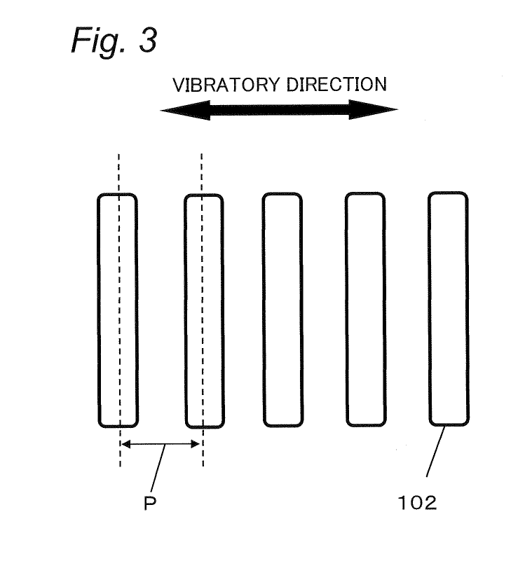

Arrangements of the electrodes 102 and the electrets 101 will be described with reference to FIG. 3. FIG. 3 is a diagram when the upper surface of the lower substrate 111 is viewed from a direction vertical to the upper surface of the lower substrate 111.

As shown in FIG. 3, the electrode 102 is arranged to extend in, a direction vertical to a vibratory direction of the movable substrate 110 and a direction parallel with the upper surface of the lower substrate 111. P in FIG. 3 indicates a distance between center lines of the adjacent electrodes 102. The plurality of the electrodes 102 is arranged to be parallel with each other at equal intervals P between the center lines. For example, the width of the electrode 102 (a dimension of the direction in which the movable substrate 110 can vibrate) is 100 μm, and the distance P is 200 μm.

The plurality of the electrets 101 may be arranged on the surface of the movable substrate 110 on the side of the lower substrate 111 to match with the electrode 102 when viewed from the direction vertical to the upper surface of the lower substrate 111. That is to say, the electrets 101 whose size is the same as the electrodes 102 may be arranged at the equal intervals P between the center lines. Note that the width of the electret 101 may be different from that of the electrode 102. In that case, the electrets 101 may be arranged so that the center lines of the electrets 101 are overlapped with the center lines of the electrodes 102 at the same intervals P between the center lines.

In such a manner, the plurality of the electrodes 102 and the plurality of the electrets 101 are arranged in the direction where the movable substrate 110 can vibrate at equal intervals.

### 1-2. Operation

### 1-2-1. Power Generating Operation of Power Generating Device

Again with reference to FIGS. 2A and 2B, the power generating operation of the power generating device 100a will be described. In the power generating device 100a, the movable substrate 110 follows a force received from an external environment (for example, vibration) to vibrate. A spring constant and a resonance frequency of the elastic structures 112 are optimized so that a maximum vibration is generated with respect to a vibration frequency of an assumed external environment (for example, a vibration at a time of running of an automobile).

In vibration, the movable substrate 110 repeats a state that opposed areas of the electrodes 102 and the electrets 101 are maximum as shown in FIG. 2A and a state that the opposed areas of the electrodes 102 and the electrets 101 are small as shown in FIG. 2B.

Since the lines of electric force of the electrets 101 direct from the movable substrate 110 towards the lower substrate 111, as the opposed areas of the electrodes 102 and the electrets 101 is larger, electric charges attracted to the electrodes 102 increase (power feeding). On the contrary, as the opposed areas are smaller, the electric charges attracted to the electrodes 102 decrease more, namely, the electric charges to be released increase more (electric discharge). That is to say, as the opposed areas of the electrodes 102 and the electrets 101 are larger, a capacitance value between the electrodes 102 and the electrets 101 is larger. As the opposed areas are smaller, the capacitance value is smaller.

When the opposed areas of the electrodes 102 and the electrets 101 are large and the electric charges are attracted to the electrodes 102, an electric current flows from the pad 105 to the AC/DC converting circuit 210. On the other hand, the electric charges attracted to the electrodes 102 are released due to the decreased opposed areas, the electric current flows from the AC/DC converting circuit 210 to the pad 105. Such an operation of the power generating device 100a generates an alternating current.

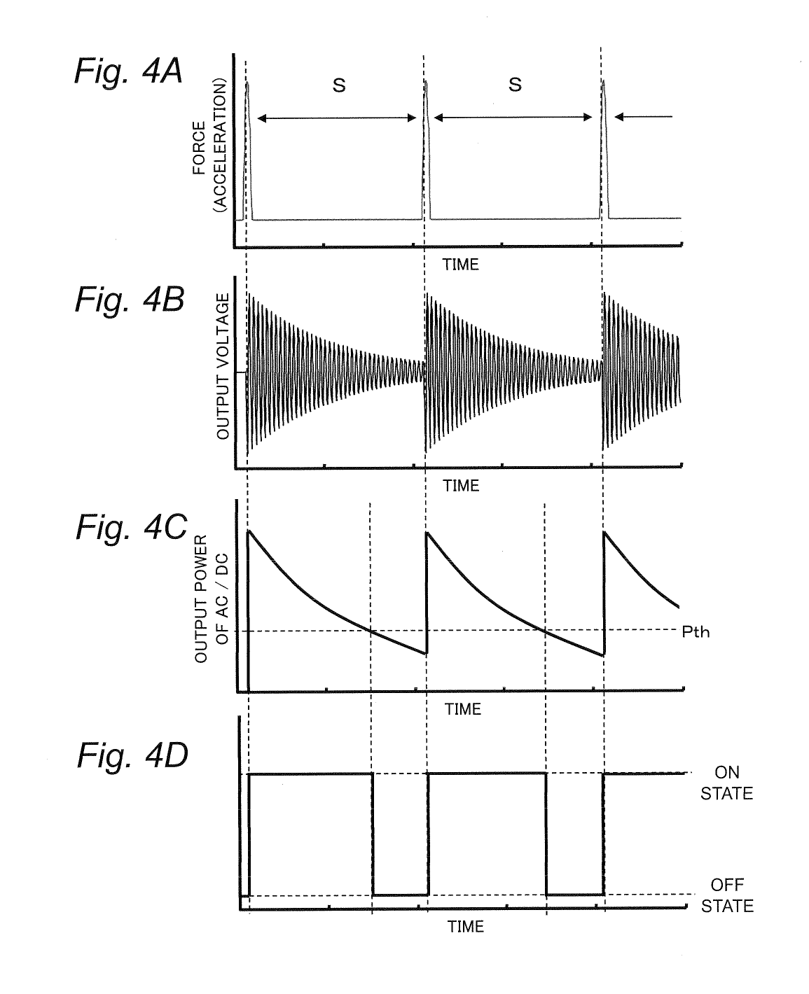

Next, a relationship between the vibration due to the external environment and the power generation of the power generating device 100a will be described. The vibration environment where the power generating device 100a is used includes a vibration environment where constant vibration is continuously generated and a vibration environment where a single impact is generated. In an example shown in FIGS. 4A to 4D, a single impact is applied to the power generating device 100a.

FIG. 4A illustrates a time change in a force (acceleration) applied to the power generating device 100a from the external environment. FIG. 4B illustrates a time change in the output voltage of the power generating device 100a according to the applied force. FIGS. 4C and 4D are described later. When a single impact is applied to the power generating device 100a (FIG. 4A), the movable substrate 110 of the power generating device 100a freely vibrates and the vibration is attenuated with time. The output from the power generating device 100a is attenuated according to the attenuated vibration (FIG. 4B).

### 1-2-2. Operation of Power Management Circuit

### (1) At Time of Normal Power Generation

The operation of the power management circuit 200a at time when the power generating device 100a generates an alternating current will be described with reference to FIGS. 4A to 4D. FIG. 4C illustrates a time change in the power to be output by the AC/DC converting circuit 210 and input into the DC/DC converting circuit 220a. Pth indicates the lower limit value of power. FIG. 4D illustrates an ON/OFF state of a power converting operation in the DC/DC converting circuit 220a.

The AC/DC converting circuit 210 converts an AC voltage (FIG. 4A) output by the power generating device 100a into a DC voltage to output as described above. The power detector 230a of the power management circuit 200a detects the output power of the AC/DC converting circuit 210. Note that a voltage level at an output end of the AC/DC converting circuit 210 is proportional to an amplitude of the AC voltage before conversion, and the power of DC voltage is proportional to a level of the DC voltage. Thus, the output power of the AC/DC converting circuit 210 is proportional to the amplitude of the AC voltage output by the power generating device 100a (FIG. 4C). Therefore, the power detector 230a detects the output power of the AC/DC converting circuit 210 to detect the amplitude of the AC voltage output by the power generating device 100a. The power detector 230a inputs information based on the detected power into the controller 240a.

The controller 240a grasps the power input into the DC/DC converting circuit 220a based on the input power information and switches presence/non-presence of the power converting operation of the DC/DC converting circuit 220a. When determining that the power input into the DC/DC converting circuit 220a exceeds the lower limit value of power, the controller 240a makes the DC/DC converting circuit 220a (continuously) perform the converting operation (“ON state” in FIG. 4D). Therefore, the DC/DC converting circuit 220a applies a voltage suitable for the storage battery 900 connected to the subsequent stage to supply a power to the storage battery 900.

(2) At Time when Vibration (Generated Power) is Too Weak

On the other hand, the generated power of the power generating device 100a reduces, and thus the power to be input into the DC/DC converting circuit 220a reduces in some cases. The operation of the power management circuit 200a in this case will be described below. The power management circuit 200a converts a power generated by a vibration energy into a power of a current value and a voltage value suitable for a load (device, the storage battery) at the subsequent stage so that the power is effectively used. However, power loss associated with the power conversion occurs in the power management circuit 200a. The power loss is caused by power consumption of the power management circuit 200a itself.

As described above, when the force applied to the power generating device 100a is a single impact, the generation power output gradually reduces. In conjunction with the reduction in the output, the power output by the DC/DC converting circuit 220a reduces. When the power output by the DC/DC converting circuit 220a reduces, the power output by the DC/DC converting circuit 220a might be soon not more than the power consumed by the power management circuit 200a.

For example as shown in FIG. 4A, a case where a single impact is applied to the power generating device 100a at every constant period S will be considered. Time for which the power stored in the storage battery 900 is not more than the power consumption of the power management circuit 200a is 30% of the period S in this example (FIG. 4C). That is to say, 30% of the power consumed by the power converting operation of the DC/DC converting circuit 220a does not contribute to improvement of the generating efficiency, and also is not less than the power output from the power management circuit 200a. Therefore, it is not useful that the DC/DC converting circuit 220a performs the converting operation for 30% of the period.

Under such a condition, the power management circuit 200a cannot apply a sufficient power to the storage battery 900 at the subsequent stage, and the power stored in the storage battery 900 reduces without power supply to an external sensor or the like. This is a problem of the power generator 1000a that should stably supply a power.

In order to solve such a problem, when determining that the power input into the DC/DC converting circuit 220a is not more than the lower limit value of power, the controller 240a stops the converting operation of the DC/DC converting circuit 220a (“OFF state” in FIG. 4D). As a result, the power consumption of the DC/DC converting circuit 220a is made to be zero. That is to say, the power consumption can be reduced further than a case where the DC/DC converting circuit 220a is continuously operated. In this example, since time for which the power input into the DC/DC converting circuit 220a is not more than the lower limit value of power is 30% of the period S, the power consumption can be reduced by 30% in comparison with the case where the DC/DC converting circuit 220a is continuously operated.

### 1-3. Conclusion of the Present Embodiment

As described above, the power generator 1000a according to the present embodiment includes the power generating device 100a that generates a power by receiving vibration, and the AC/DC converting circuit 210 and the DC/DC converting circuit 220a that convert the output from the power generating device 100a, the power detector 230a that detects the output power from the power generating device 100a, and the controller 240a that switches presence/non-presence of power conversion of the DC/DC converting circuit 220a. When determining that, for example, the output from the power generator 1000a is not more than the power consumption of the power generator 1000a based on the power information detected and output by the power detector 230a, the controller 240a stops the power conversion of the DC/DC converting circuit 220a.

With this configuration, the power generator 1000a according to the present embodiment, when the output from the power generator 1000a is not more than a predetermined value, for example, not more than the power consumption of the power generator 1000a, set the power consumption of the DC/DC converting circuit 220a to be zero. As a result, the power generator 1000a can supply the power more efficiently, and thus the reliability of the power generator 1000a is further improved.

### 2. Second Embodiment

A second embodiment will be described below.

When a strong impact is applied to a vibration-type power generating device, the output abruptly increases. For this reason, a high-power (voltage) signal is input into the power management circuit, and thus the power management circuit might break down. This example is a case where a high voltage that exceeds a defined value of the DC/DC converter is input into the DC/DC converter. The power generator according to the present embodiment reduces at least occurrence of a failure of the power management circuit caused by such a strong impact.

### 2-1. Configuration and Operation of Power Generator

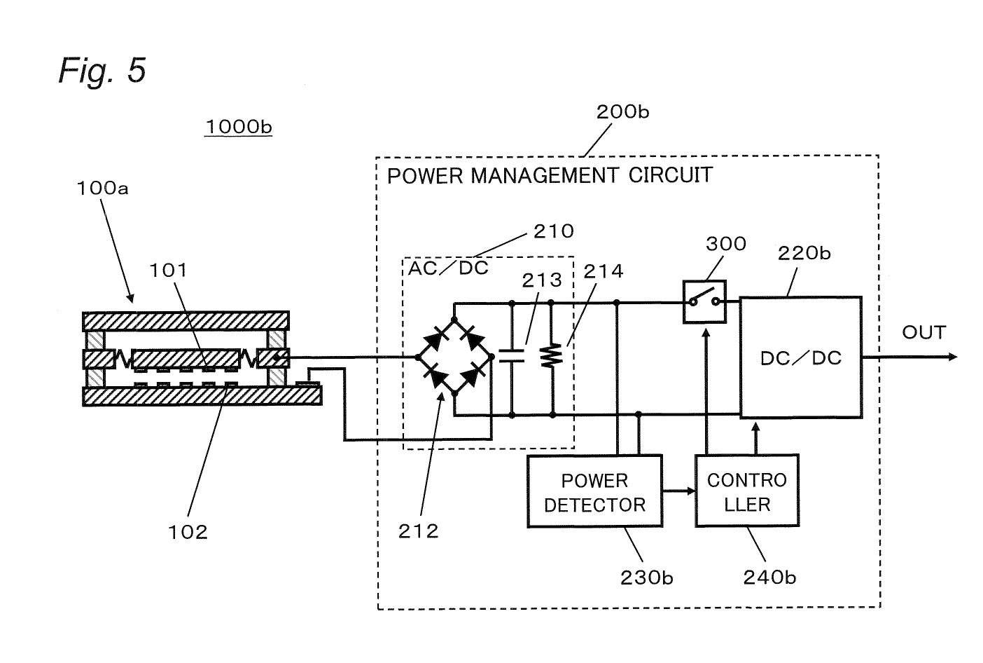

The present embodiment has a configuration shown in FIG. 5. A switch 300 is connected between the AC/DC converting circuit 210 and the DC/DC converting circuit 220b in series, and a controller 240b and the switch 300 are connected. The other parts may be similar to the configuration of the first embodiment. In FIG. 5, the load 900, the external sensor, and the like are omitted.

In the present embodiment, similarly to the first embodiment, a power detector 230b detects the power output by the AC/DC converting circuit 210. The controller 240b switches the ON/OFF state of the switch 300 based on the power detected by the power detector 230b.

The controller 240b according to the present embodiment stores an upper limit value of power. “The upper limit value of power” is a value corresponding to an upper limit of the power capable of being input into the DC/DC converting circuit 220b.

When determining that the power output from the AC/DC converting circuit 210 is less than the upper limit value of power, the controller 240b brings the switch 300 and the DC/DC converting circuit 220b into the ON state (or the ON state is maintained), and causes the DC/DC converting circuit 220b to convert and output the power.

On the other hand, when determining that the power output from the AC/DC converting circuit 210 is not less than the upper limit value of power, the controller 240b switches the switch 300 and the DC/DC converting circuit 220b into the OFF state. As a result, the input into the DC/DC converting circuit 220b is blocked.

For example, when a specified voltage of the DC/DC converting circuit 220b is 40 V and the voltage of the power output from the AC/DC converting circuit 210 is 60 V, the controller 240b switches the switch 300 into the OFF state, and prevents application of the voltage of 60 V to the DC/DC converting circuit 220b.

### 2-2. Conclusion of the Present Embodiment

As described above, the power generator 1000b according to the present embodiment includes the power generating device 100a that generates a power by receiving vibration, the AC/DC converting circuit 210 and the DC/DC converting circuit 220b that convert the output from the power generating device 100a, the power detector 230b that detects the output power from the power generating device 100a, the switch 300 connected between the AC/DC converting circuit 210 and the DC/DC converting circuit 220b in series, and the controller 240b that switches conduction/non-conduction of the switch 300. When determining that the output power of the AC/DC converting circuit 210 is not less than the upper limit value of power based on the power information output from the power detector 230b, The controller 240b brings the switch 300 into the non-conductive state.

With this configuration, when the output from the power generating device 100a is excessive, the power generator 1000b according to the present embodiment blocks the input into the DC/DC converting circuit 220b. As a result, failure of the DC/DC converting circuit 220b caused by the excessive power output from the power generating device 100a can be prevented, and thus the reliability of the power generator 1000b can be improved.

Note that, similarly to the first embodiment, a power management circuit 200b according to the present embodiment may be configured so that, when the input power into the DC/DC converting circuit 220b is not more than the lower limit value of power, the controller 240b stops the DC/DC converting circuit 220b. As a result, the present embodiment also enables the power management circuit 200b to efficiently supply a power to external devices, and thus the reliability of the power generator 1000b is further improved.

### 3. Third Embodiment

A third embodiment will be described below.

In the second embodiment, the controller 240b configured to switch the switch 300. In the present embodiment, the switch itself passively switches blocking/supply of the power to the DC/DC converting circuit according to the input into the DC/DC converting circuit.

### 3-1. Configuration and Operation of Power Generator

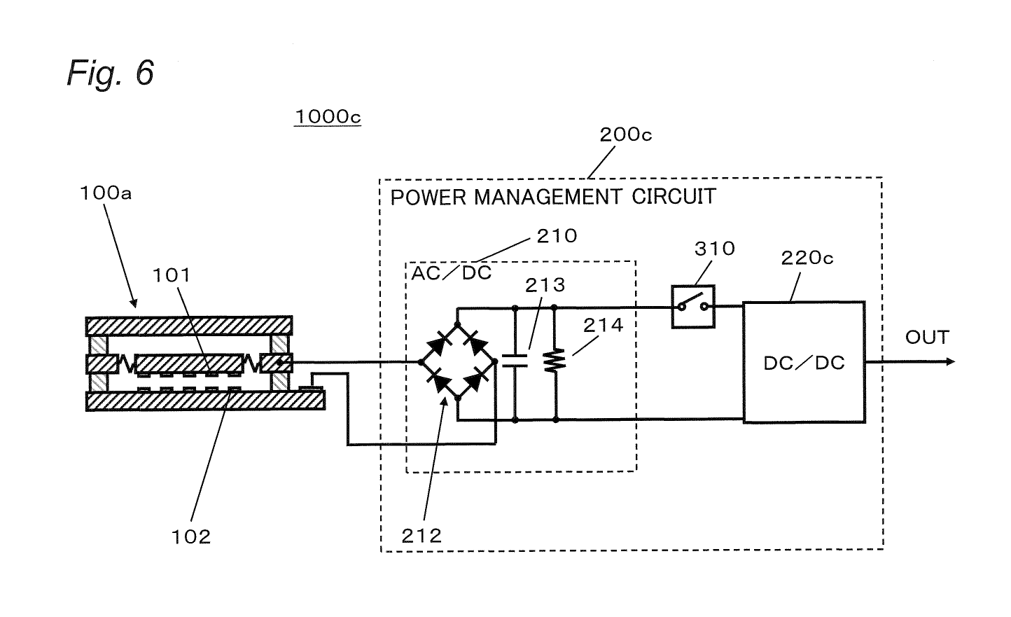

The present embodiment has a configuration shown in FIG. 6. When the configuration according to the present embodiment is compared with the second embodiment shown in FIG. 5, the present configuration may be similar to the second embodiment except for non-provision of the power detector 230b and the controller 240b and provision of a passive switch 310 instead of the switch 300.

The passive switch 310 is connected between the AC/DC converting circuit 210 and the DC/DC converting circuit 220c in series. The passive switch 310 switches conduction/non-conduction according to an input voltage. When the input voltage is high, the passive switch 310 is conductive, and when the input voltage is low, the passive switch 310 is non-conductive. The passive switch 310 is, for example, an electrostatic-driven type switch formed by an MEMS technique. Details of the passive switch 310 are described below.

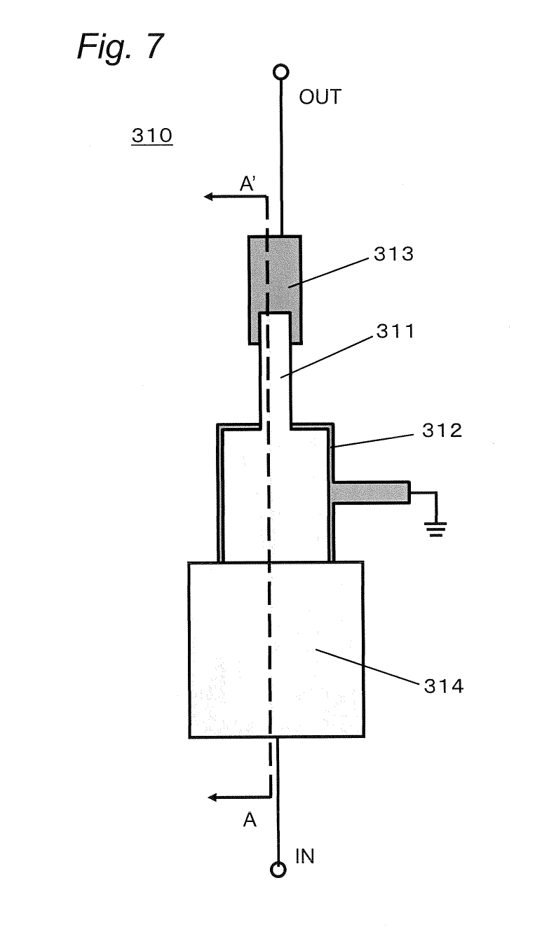

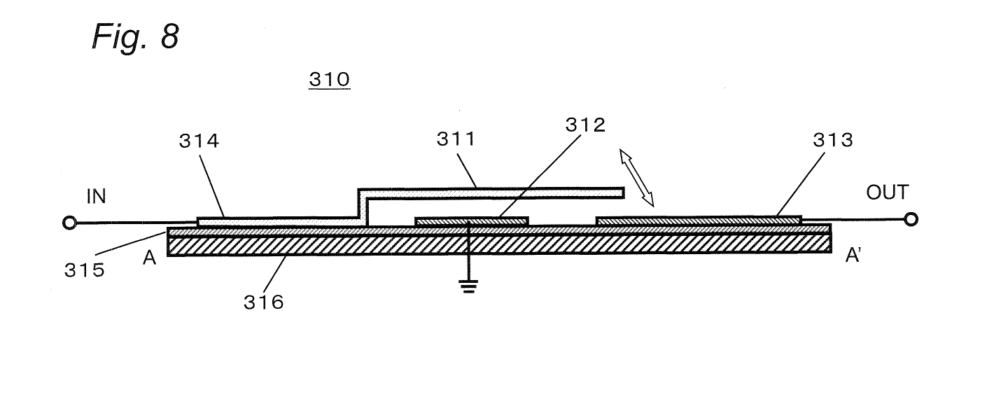

A configuration of the passive switch 310 according to the present embodiment will be described with reference to FIG. 7 and FIG. 8. FIG. 8 is a cross sectional view taken along line A-A′ of FIG. 7. As shown in FIG. 7, the passive switch 310 is composed of a substrate 316, an insulating layer 315, a movable electrode 311, an output electrode 313, an input electrode 314, and a driving electrode 312.

The insulating layer 315 is an interlayer insulating film that is jointed between the substrate 316 and the driving electrode 312, between the substrate 316 and the output electrode 313, and between the substrate 316 and the input electrode 314. The movable electrode 311 is a cantilever type electrode whose one end is jointed to the input electrode 314, and whose other end is formed to be separated by a predetermined interval from the output electrode 313. The end cross-linked in a midair is formed and arranged to be curved and thus contact with the output electrode 313. A two-way arrow in FIG. 8 indicates the curve. The driving electrode 312 is jointed to the insulating layer 315 in a space between the movable electrode 311 and the insulating layer 315. Further, the driving electrode 312 is electrically grounded. The output electrode 313 is jointed to the insulating layer 315. The input electrode 314, the output electrode 313 and the driving electrode 312 are arranged to be electrically insulated from each other. The passive switch 310 having such a configuration is connected between the AC/DC converting circuit 210 and the DC/DC converting circuit 220c in series.

In a power generator 1000c according to the present embodiment, similarly to the above embodiment, the power generating device 100a generates and outputs a power, and the AC/DC converting circuit 210 and the DC/DC converting circuit 220c convert the power, and the DC/DC converting circuit 220c outputs the power to the load (the storage battery) 900 at the subsequent state. At this time, according to the power (voltage) output from the AC/DC converting circuit 210, the passive switch 310 blocks or permits the input into the DC/DC converting circuit 220c. The specific operation of the passive switch 310 will be described below.

The passive switch 310 switches conduction/non-conduction with a predetermined lower limit value of voltage. “The lower limit value of voltage” may be, similarly to the lower limit value of power according to the first embodiment, a value corresponding to the output voltage from the AC/DC converting circuit 210 at time when an output power of a power management circuit 200c is equal to a power consumption of the power management circuit 200c. The lower limit value of voltage is defined by dimensions, materials arrangements, and the like of respective sections composing the passive switch 310.

When a potential difference is generated between the movable electrode 311 and the driving electrode 312, an electrostatic force acts between the movable electrode 311 and the driving electrode 312, and thus the movable electrode 311 curves towards the driving electrode 312.

When a voltage input into the input electrode 314 of the passive switch 310 exceeds the lower limit value of voltage, the potential difference between the movable electrode 311 and the driving electrode 312 exceeds a predetermined value, and the movable electrode 311 that curves due to the electrostatic force contacts with the output electrode 313 to be electrically connected. That is to say, the input electrode 314 and the output electrode 313 are electrically conductive.

Due to such an operation of the passive switch 310, the power output from the AC/DC converting circuit 210 is input into the DC/DC converting circuit 220c. The DC/DC converting circuit 220 converts the input power to output the converted power to the storage battery 900 at the subsequent state. That is to say, a charging operation is performed.

On the other hand, when the voltage output by the AC/DC converting circuit 210 is not more than the lower limit value of voltage, the electrostatic force for curving the movable electrode 311 is weakened. For this reason, the connection between the movable electrode 311 and the output electrode 313 is terminated. As a result, the input from the AC/DC converting circuit 210 into the DC/DC converting circuit 220c is blocked.

Since the input into the DC/DC converting circuit 220c is blocked, the power converting operation in the DC/DC converting circuit 220c stops. That is to say, when the power output from the DC/DC converting circuit 220c is not more than the power consumption of the power management circuit 200c as a result of the power converting operation in the DC/DC converting circuit 220c, the passive switch 310 moves into the OFF state, and thus the DC/DC converting circuit 220c does not perform the converting operation.

Note that the electrostatic force that acts between the movable electrode 311 and the driving electrode 312 is generated when a potential difference is generated between the movable electrode 311 and the driving electrode 312. The above example shows the case where the potential of the movable electrode 311 is higher than the potential of the driving electrode 312. However, the potential of the movable electrode 311 is occasionally lower than the potential of the driving electrode 312, and also in this case, the electrostatic force that causes the movable electrode 311 and the driving electrode 312 to be attracted to each other is generated. In the present embodiment, only the case where the potential of the movable electrode 311 is higher than the potential of the driving electrode 312 is assumed. However, the configuration may utilize an electrostatic force that is generated when the potential of the movable electrode 311 is lower than the potential of the driving electrode 312.

### 3-2. Conclusion of the Present Embodiment

As described above, the power generator 1000c according to the present embodiment includes the power generating device 100a that generates a power by receiving vibration, the AC/DC converting circuit 210 and the DC/DC converting circuit 220c that converts the output from the power generating device 100a, and the passive switch 310 that switches presence/non-presence of the power conversion in the DC/DC converting circuit 220c according to the voltage output from the AC/DC converting circuit 210.

With this configuration, the power generator 1000c according to the present embodiment, for example, when the output from the power generator 1000c is not more than the power consumption of the power generator 1000c, causes the power consumption of the DC/DC converting circuit 220c to be zero. As a result, similarly to the first embodiment, the power generator 1000c can supply a power more efficiently, and thus the reliability of the power generator 1000c is further improved.

Further, when provided with the passive switch 310, the power generator 1000c according to the present embodiment does not have to be provided with the power detector and the controller in comparison with the former embodiment and thus the circuit scale of the power generator 1000c can be further reduced.

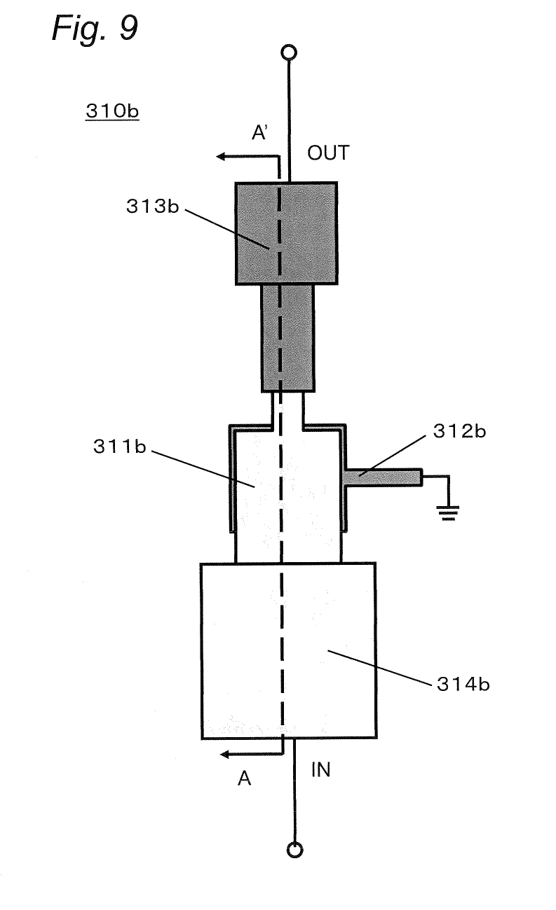

As a modified example of the passive switch 310 according to the present embodiment, a passive switch 310b shown in FIG. 9 may be provided. When the output voltage of the AC/DC converting circuit 210 is not less than a predetermined value, the passive switch 310b blocks the input of the voltage into the DC/DC converting circuit 220c.

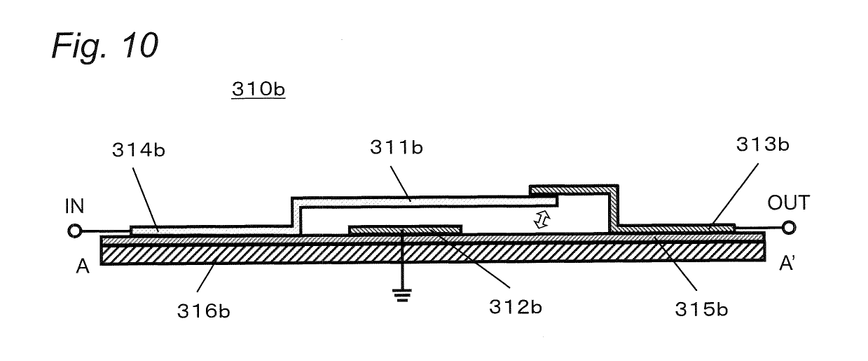

The passive switch 310b will be described with reference to FIG. 10. FIG. 10 is a cross sectional view taken along line A-A′ of FIG. 9. In comparison with the passive switch 310 shown in FIG. 8, the configuration of the passive switch 310b is similar to the passive switch 310 except that a difference in the shape of the output electrode 313b. The movable electrode 311b is formed to be capable of being curved by the electrostatic force generated between the movable electrode 311b and the driving electrode 312b. A two-way arrow in FIG. 10 indicates the curve. When the voltage applied to the input electrode 314b is lower than an upper limit value of voltage, the movable electrode 311b does not curve and contacts with the output electrode 313b, and thereby the movable electrode 311b is electrically connected to the output electrode 313b. On the other hand, when the voltage applied to the input electrode 314b is not less than the upper limit value of voltage, the movable electrode 311b curves, and thereby the connection between the movable electrode 311b and the output electrode 313b is terminated. “The upper limit value of voltage” corresponds to an upper limit value of voltage capable of being input into the DC/DC converting circuit 220c.

When a voltage that is less than the upper limit value of voltage is input into the input electrode 314b, the movable electrode 311b is connected to the output electrode 313b, and thus the input electrode 314b and the output electrode 313b are conductive. Therefore, the charging operation is performed on the storage battery 900. On the other hand, when a voltage that is not less than the upper limit value of voltage is input into the input electrode 314b, the movable electrode 311b curves, and thus the connection between the movable electrode 311b and the output electrode 313b is terminated. For this reason, the input electrode 314b and the output electrode 313b are non-conductive. Therefore, the input into the DC/DC converting circuit 220c is blocked.

Since the passive switch 310b can prevent a failure due to an excessive voltage to be input into the DC/DC converting circuit 220c, the reliability of the power generator 1000c is further improved.

Further, the passive switch 310 and the passive switch 310b may be connected in series. In that case, the power generator 1000c can cope with both the stopping of the power converting operation in the DC/DC converting circuit 220c during low power generation and the protection of the DC/DC converting circuit 220c during high power generation.

### 4. Fourth Embodiment

A fourth embodiment will be described below.

In the first to third embodiments, in order to grasp the output from the power generating device 100a, the power output from the AC/DC converting circuit 210 is detected. In the present embodiment, in order to grasp the output from the power generating device 100a, vibrational amplitude of the movable substrate 110 in the power generating device 100a is detected.

### 4-1. Configuration and Operation of Power Generator

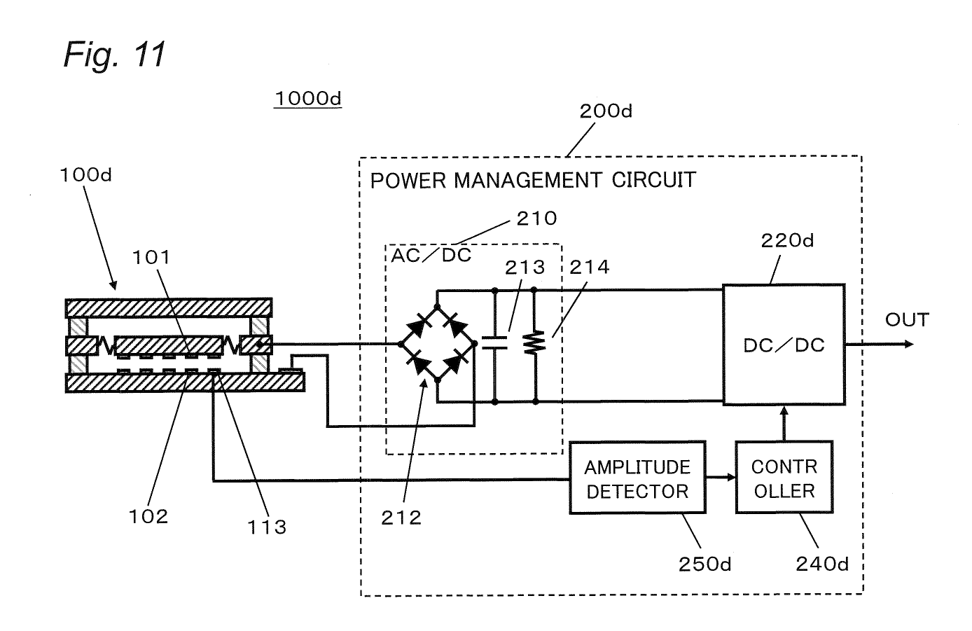

The present embodiment has a configuration shown in FIG. 11. In comparison with the configuration according to the first embodiment shown in FIG. 5, the configuration according to the present embodiment is different in the power generating device 100d, and has an amplitude detector 250d instead of the power detector 230a. The other parts of the configuration may be similar to the first embodiment.

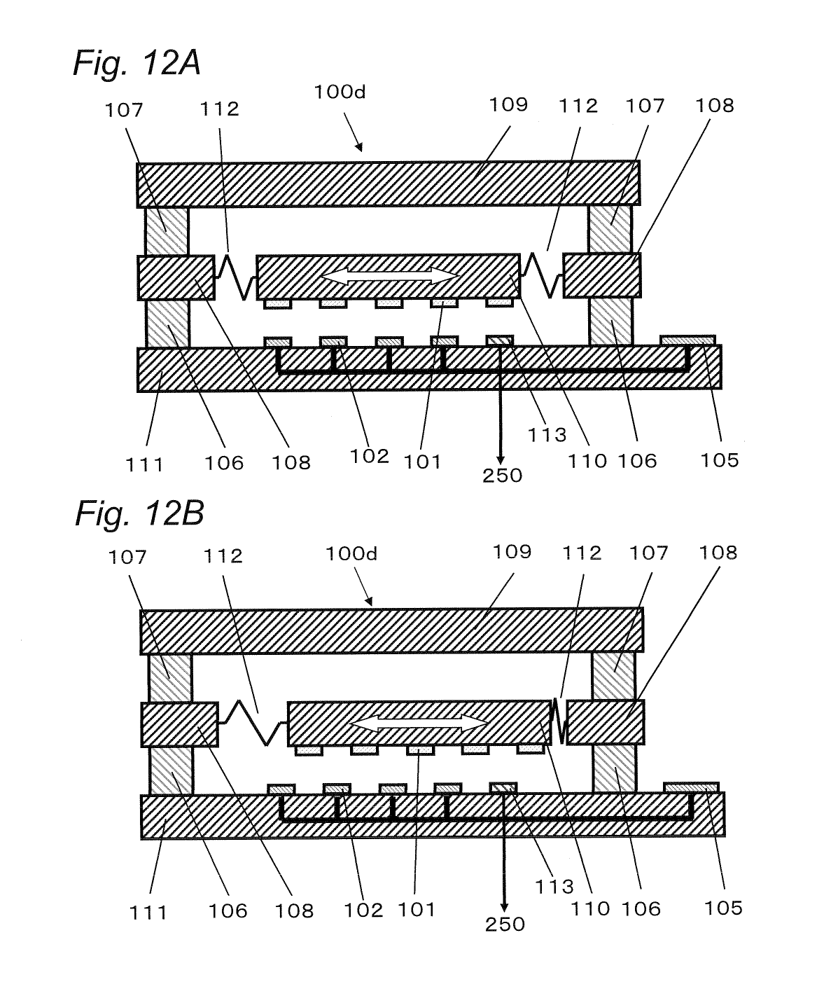

The configuration of the power generating device 100d will be described with reference to FIGS. 12A and 12B. The power generating device 100d has an amplitude detection electrode 113. The amplitude detection electrode 113 is disposed on a position where the electrode 102 is originally disposed instead of the electrode 102. The amplitude detection electrode 113 is formed to be electrically insulated from the electrode 102.

Note that one or a plurality of amplitude detection electrodes 113 may be disposed. However, a configuration where the number of the amplitude detection electrodes 113 is small is advantageous in order that as many electrodes 102 for power generation as possible can be arranged. More preferably, the number of the amplitude detection electrode 113 is one. Further, the amplitude detection electrode 113 may be arranged at the endmost in the plurality of the electrodes 102, or may be in a line of the electrodes 102. However, in order to simplify a layout of wiring to be extracted from the electrode 102 and the amplitude detection electrode 113, the case where the amplitude detection electrode 113 is arranged at the endmost is advantageous.

The wiring extracted from the amplitude detection electrode 113 is electrically insulated from the wiring to the AC/DC converting circuit 210 and is connected to the amplitude detector 250d. The amplitude detector 250d is connected to a controller 240d. The other parts of the configuration may be similar to the first embodiment.

In the power generator 1000d according to the present embodiment, similarly to the above embodiments, the power generating device 100d generates and outputs a power, the AC/DC converting circuit 210 and the DC/DC converting circuit 220d converts the power, and the DC/DC converting circuit 220d outputs the power to the load 900 at the subsequent state.

At this time, the amplitude detection electrode 113 provided to the power generating device 100d outputs an alternating current similarly to the electrode 102 that outputs an alternating current. A phase of an envelope of the alternating current output from the amplitude detection electrode 113 is equal to a phase of attenuation of the movable substrate 110 in the power generating device 100d. That is to say, the increase/decrease in the amplitude of the alternating current output from the amplitude detection electrode 113 respond well to strength of the amplitude of the movable substrate 110.

The amplitude detector 250d detects the vibrational amplitude of the movable substrate 110 through the alternating current output from the power generating device 100d. The amplitude detector 250d inputs amplitude information to the controller 240d according to the detected amplitude.

The output power from the power generating device 100d into the amplitude detector 250d is proportional to the output power from the power generating device 100d to the AC/DC converting circuit 210. Therefore, detecting the vibrational amplitude of the movable substrate 110 through the amplitude detector 250d corresponds to detecting the output power from the power generating device 100d into the AC/DC converting circuit 210.

The controller 240d switches the converting operation of the DC/DC converting circuit 220d between execution and stopping based on the amplitude information input by the amplitude detector 250d similarly to the controller 240a of the first embodiment.

The amplitude (power) of the alternating current output from the amplitude detection electrode 113 according to the present embodiment may be smaller than the amplitude (power) of the alternating current output to the AC/DC converting circuit 210. Therefore, the power to be output to the AC/DC converting circuit 210 can be increased as much as possible. That is to say, the electric current to be output to the AC/DC converting circuit 210 can be increased more.

Further, the alternating current for supplying power output to the AC/DC converting circuit 210 and the alternating current for control output to the amplitude detector 250d are generated by vibration of one common movable substrate 110. Therefore, vibration phases of the alternating current for supplying power and the alternating current for control are equal to each other, and their vibrational amplitudes are proportional to each other.

On the other hand, that the two power generating devices are disposed together might be considered. One of power generating device generates a power for supplying power, and the other power generating device generates a power for control. However in that configuration, the vibrational amplitude of the power generating device for supplying power may increase, but the vibrational amplitude of the power generating device for control may decrease. In such a condition, that even use of the electric current output form the power generating device for control does not enable the DC/DC converting circuit 220d to be suitably controlled is considered. This point provides an advantage such that the configuration according to the present embodiment can control the DC/DC converting circuit 220d more accurately.

### 4-2. Conclusion of the Present Embodiment

As described above, the power generator 1000d according to the present embodiment includes the power generating device 100a that generates a power by receiving vibration, the AC/DC converting circuit 210 and the DC/DC converting circuit 220d that converts the output from the power generating device 100a, the amplitude detector 250d that detects the vibrational amplitude of the movable electrode 110 inside the power generating device 100d, and the controller 240d that switches presence/non-presence of power conversion of the DC/DC converting circuit 220d. When the controller 240d determines that, for example, the output from the power generator 1000c is not more than the power consumption of the power generator 1000c based on the amplitude information output from the amplitude detector 250d, the power converting operation of the DC/DC converting circuit 220d is suspended.

With this configuration, the power generator 1000d according to the present embodiment, for example, when the output from the power generator 1000d is not more than the power consumption of the power generator 1000d, can set the power consumption of the DC/DC converting circuit 220d to zero. As a result, the power can be supplied more efficiently, and the reliability of the power generator 1000d is further improved.

### 5. Fifth Embodiment

A fifth embodiment will be described below.

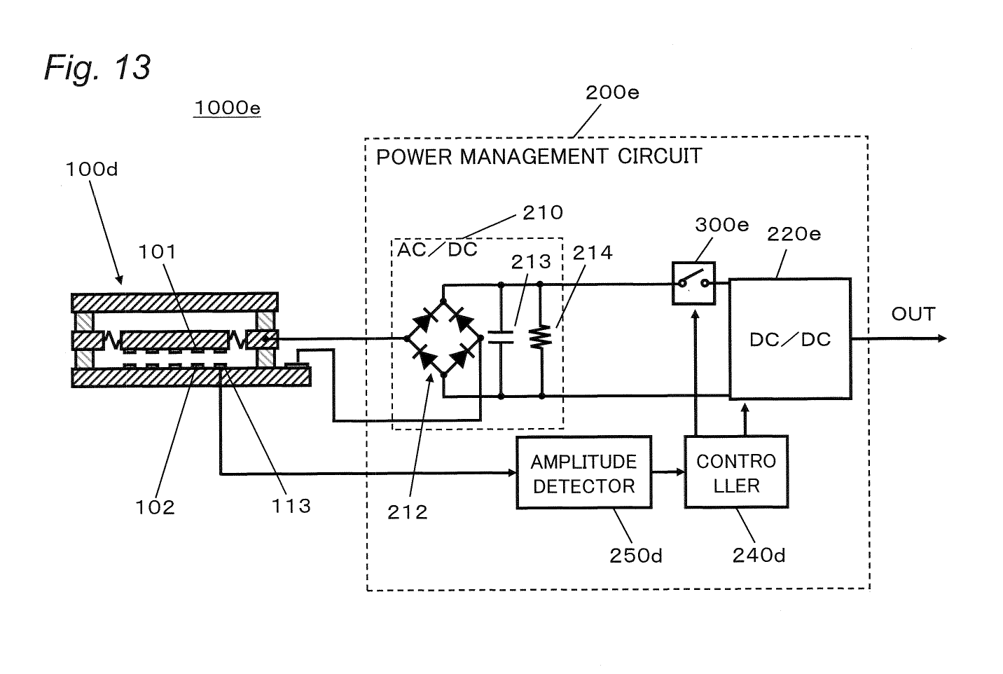

As shown in FIG. 13, the fifth embodiment has a configuration such that a switch 300e is added to the power generator 1000c according to the fourth embodiment shown in FIG. 11. The switch 300e is connected between the AC/DC converting circuit 210 and a DC/DC converting circuit 220e in series.

Even in such a configuration, when the output power of the power generating device 100d reduces, similarly to the fourth embodiment shown in FIG. 11, the DC/DC converting circuit 220e is stopped so that a power can be supplied more efficiently. Further, when the generated power from the power generating device 100d remarkably increased, similarly to the second embodiment shown in FIG. 5, the switch 300e moves into the OFF state so that a failure of the DC/DC converting circuit 220e can be reduced.

### 6. Variants

Variants of the first to fifth embodiments will be described below.

Some embodiments have a configuration for reducing a failure of the DC/DC converting circuit. In order to reduce a failure of a circuit other than the DC/DC converting circuit, an excessive voltage input into that circuit may be blocked. In that case, an upper limit value of an input voltage suitable for that circuit is defined.

In the first to fifth embodiments, the movable substrate 110 of the power generating devices 100a and 100d is jointed to the upper joints 107 and the lower joints 106 via the springs 112 and the fixed structures 108, and thus is arranged to be separated from the upper substrate 109 and the lower substrate 111. However, the movable substrate 110 may be fixed by another method. Any method may be used as long as the method does not hinder the vibration of the movable substrate 110. For example, the movable substrate 110 may be supported by an electrostatic force or a magnetic force. For example, electrets for supporting the movable substrate 110 are disposed on the upper substrate 109 and the lower substrate 111, and the movable substrate 110 may be fixed by an electrostatic force between these electrets and the electrets 101 provided onto the movable substrate 110.

Further, in the first to fifth embodiments, the movable substrate 110 of the power generating device vibrates in a direction indicated by the two-way arrow in FIGS. 2A and 2B. However, this does not exclude a vibration in directions other than the two-way arrow.

Further, by incorporating the power generator according to the first to fifth embodiments into electric equipments, electric equipments that can control power and has high reliability can be provided.

Next, sixth and seventh embodiments will be described below with reference to the accompanying drawings.

In a conventional power generator that generates a power by the vibration-type power generating device (power generating device), when an output from a vibration-type power generating device is decreased, energy conversion efficiency of a power convertor (the power management circuit) decreases, and thus the generating efficiency of the power generator entirely decreases. Therefore, also in the power generator having the vibration-type power generating device, in order to suppress the decrease in generating efficiency to the minimum, that the power management circuit is controlled optimally based on the output from the vibration-type power generating device is needed. Therefore, the sixth and seventh embodiments provide the power generator that suppresses the increase in the circuit scale to the minimum and improves the generating efficiency.

### 7. Sixth Embodiment

### 7-1. Configuration

### 7-1-1. Entire Configuration

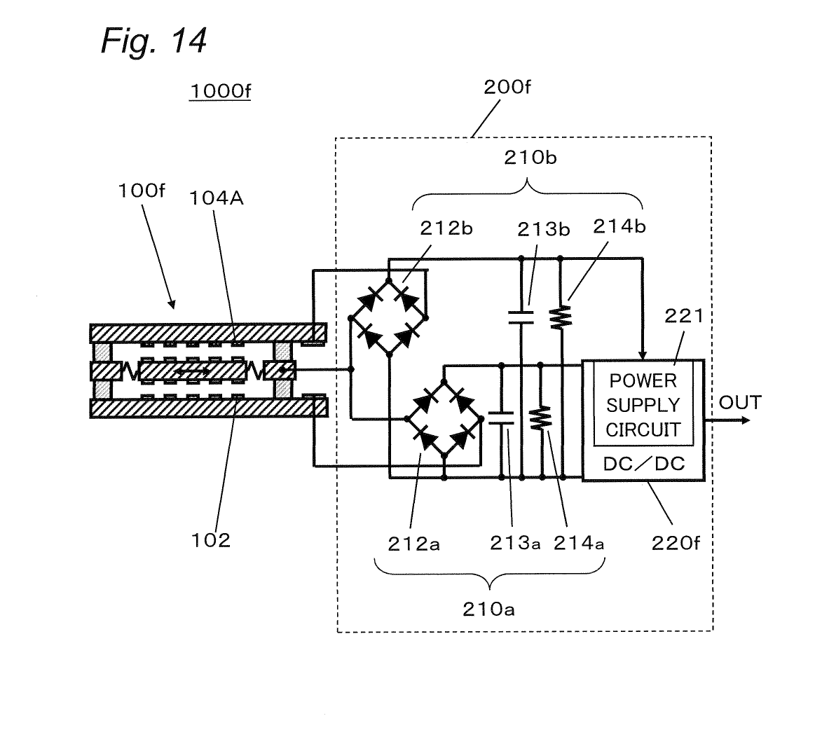

FIG. 14 is a block diagram illustrating the power generator according to the present embodiment. As shown in FIG. 14, a power generator 1000f according to the present embodiment includes a power generating device 100f, and a power convertor (a power management circuit) 200f. The power management circuit 200f includes the AC/DC converting circuit 210a for supplying power and an AC/DC converting circuit 210b for control, and the DC/DC converting circuit 220f. A power generating device 100f is a vibration-type power generating device manufactured by the MEMS (micro electric mechanical) technique. The power generating device 100f includes first electrodes 102 and second electrodes 104A connected to two systems of output, and the like. The AC/DC converting circuit 210a for supplying power and the AC/DC converting circuit 210b for control of the power convertor (the power management circuit) 200f respectively include a smoothing circuit composed of a bridge rectifier circuit 212a (212b) composed of four diodes and a capacitor 213a (213b), and a load resistance 214a (214b). The DC/DC converting circuit 220f includes a power supply circuit 221 for the DC/DC converting circuit 220f itself.

The power generating device 100f is connected to the AC/DC converting circuit 210a for supplying power by wiring connected to the first electrode 102, and is connected to the AC/DC converting circuit 210b by wiring connected to the second electrode 104A. The AC/DC converting circuit 210a for supplying power is connected to a terminal for inputting a signal of the DC/DC converting circuit 220f. The AC/DC converting circuit 210b for control is connected to the power supply circuit 221 via a terminal for connecting a power supply of the DC/DC converting circuit 220f. The output of the DC/DC converting circuit 220f, namely, the output of the power management circuit 200f is connected to the storage battery or the like at the subsequent stage to supply a power.

The power generating device 100f generates a power due to an internal vibration caused by an external force, and outputs an alternating current (power).

The AC/DC converting circuit 210a for supplying power and the AC/DC converting circuit 210b for control convert an AC power output from the power generating device 100f into a DC power.

The DC/DC converting circuit 220f converts the DC power output from the AC/DC converting circuit 210a for supplying power into a DC power of another voltage. Then, the DC/DC converting circuit 220f supplies the power to a device (the storage battery or the like) connected to the subsequent stage. The voltage converting operation of the DC/DC converting circuit 220f uses the power supplied from the AC/DC converting circuit 210b for control as motive power. The voltage converting operation of the DC/DC converting circuit 220f is switched between execution and suspension according to a relationship between the voltage of the output power from the AC/DC converting circuit 210b for control and a predetermined lower limit value of voltage.

“The lower limit value of voltage” corresponds to a lower limit value of a driving voltage of the DC/DC converting circuit 220f. Further, from a viewpoint such that the entire generating efficiency of the power generator 1000f is improved, it is advantageous that the lower limit value of voltage is set to correspond to the input voltage from the AC/DC converting circuit 210b for control into the DC/DC converting circuit 220f when the DC/DC converting circuit 220f is desired to be stopped. Details of the lower limit value of voltage will be described later.

The DC/DC converting circuit 220f according to the present embodiment is operated by a power generated by the power generating device 100f.

### 7-1-2. Configuration of Power Generating Device

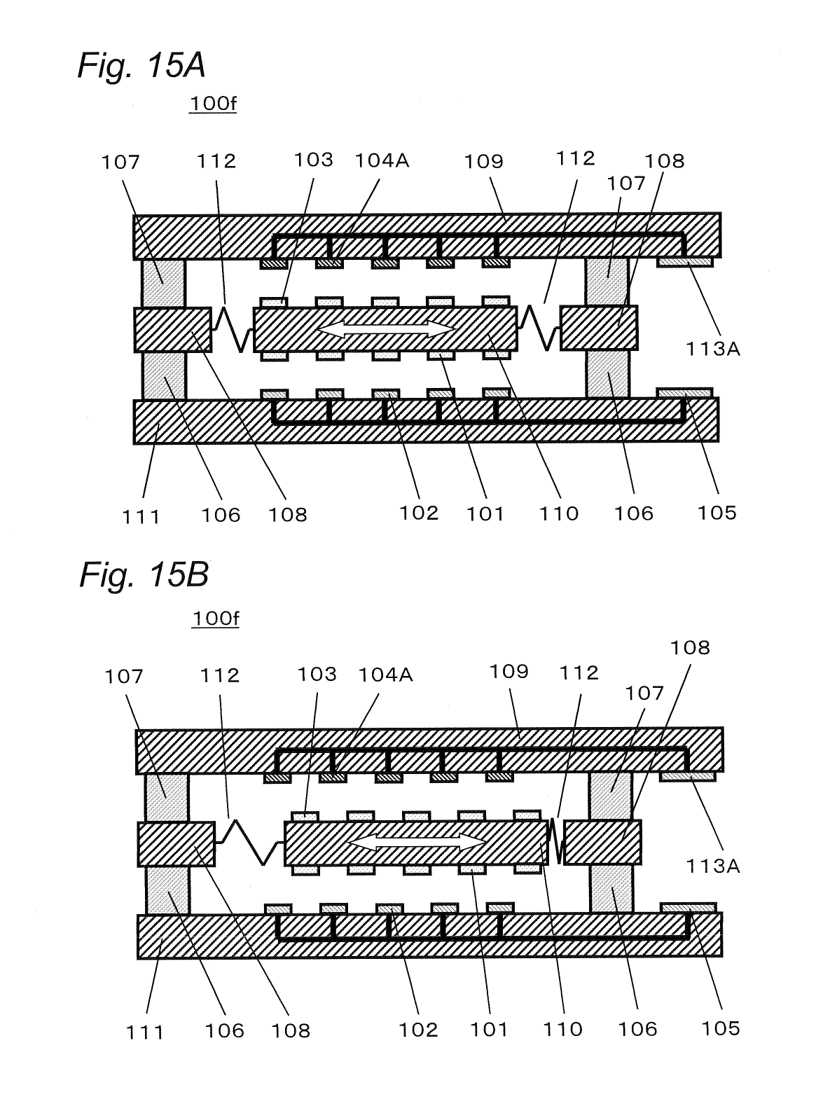

A Configuration of the power generating device 100f will be described with reference to FIGS. 15A and 15B. As describe later, the power generating device 100f has the movable substrate 110 that vibrates inside. FIG. 15A illustrates a state that the movable substrate 110 is at the center of vibration. FIG. 15B illustrates a state that the movable substrate 110 shifts from the center of vibration.

The power generating device 100f includes a lower substrate (first substrate) 111, an upper substrate (a second substrate) 109, a movable substrate (movable section, weight, the vibration body) 110, springs (elastic structures) 112, fixed structures 108, upper joints 107, lower joints 106, a plurality of first electrets 101, a plurality of second electrets 103, a plurality of first electrodes 102, a plurality of second electrodes 104, a first pad 105, and a second pad 113A.

The upper substrate 109 and the lower substrate 111 are arranged to be opposed to each other in parallel. The upper substrate 109 and the lower substrate 111 are separated by a predetermined distance from the movable substrate 110 and the springs 112 and the fixed structures (intermediate substrate) 108, and are fixed by the upper joints 107 and the lower joints 106.

The fixed structures 108, the movable substrate 110 and the springs 112 are formed by machining one substrate. Therefore, the fixed structures 108, the movable substrate 110 and the springs 112 may be “the intermediate substrate 108 to which the movable substrate 110 is connected by the elastic structures 112” or “the intermediate substrate 108 which has the weight 110 movable by the elastic structures 112”.

The movable substrate 110 is composed to move to at least one axial direction (for example, a two-way arrow direction in FIGS. 15A and 15B) parallel with the upper substrate 109 or the lower substrate 111. Therefore, the movable substrate 110 can vibrate (reciprocation motion) to a direction parallel with the upper substrate 109 according to force (vibration) applied externally as shown in FIG. 15B.

A surface of the upper substrate 109 opposed to the lower substrate 111 is a lower surface. A surface of the lower substrate 111 opposed to the upper substrate 109 is an upper surface.

The upper surface of the lower substrate 111 is provided with the plurality of first electrodes 102. Wiring for connecting the electrodes 102 is connected to the first pad 105 through the lower substrate 111. Further, the lower surface of the upper substrate 109 is provided with the plurality of second electrodes 104A. Wiring for connecting the second electrodes 104A is connected to the second pad 113A through the upper substrate 111. The first pad 105 and the second pad 113A are electrically insulated from each other. The power generating device 100f outputs generated powers through the first pad 105 and the second pad 113A, respectively.

The plurality of first electrets 101 is provided on the surface of the movable substrate 109 opposed to the lower substrate 111. Each of the first electrets 101 is provided so that the line of electric force is vertical to a lower surface of the lower substrate 111 and a direction of the line of electric force is a direction from the movable substrate 110 towards the lower substrate 111. Similarly, the plurality of second electrets 103 is provided on the surface of the movable substrate 110 opposed to the upper substrate 109. The respective second electrets 103 are provided so that a direction of the line of electric force is opposed to the direction of the line of electric force of the first electrets 101.

It is advantageous that the electrets 101 and 103 are provided so that the directions of their lines of electric force are opposite to each other. This is because, as described later, phases of alternating currents generated by vibratory motion of the electrets 101 and 103 are equal to each other. However, the electrets 101 and 103 may be provided so that the lines of electric force face the same direction. Details will be described later.

The lower substrate 111 and the fixed structures 108 are jointed by the lower joints 106 so that a predetermined gap is provided between the first electrodes 102 and the first electrets 101. Further, the upper substrate 109 and the fixed structures 108 are jointed by the upper joints 107 so that a predetermined gap is provided between the second electrodes 104A and the second electrets 103.

Arrangements of the electrodes 102 and 104A, and the electrets 101 and 103 will be described. FIG. 3 is a diagram when the upper surface of the lower substrate 111 is viewed from a direction vertical to the upper surface of the lower substrate 111. A two-way arrow in FIG. 3 indicates a vibratory direction of the movable substrate 110.

As shown in FIG. 3, the first electrode 102 is arranged to extend in, a direction vertical to a vibratory direction of the movable substrate 110 and a direction parallel with the upper surface of the lower substrate 111. P in FIG. 3 indicates a distance between center lines of the adjacent first electrodes 102. The plurality of the first electrodes 102 is arranged to be parallel with each other at equal intervals P between the center lines. For example, the width of the first electrode 102 (a dimension of the direction in which the movable substrate 110 can vibrate) is 100 μm, and the distance P is 200 μm.

The plurality of the electrets 101 is arranged on the surface of the movable substrate 110 on the side of the lower substrate 111 to match with the first electrode 102 when viewed from the direction vertical to the upper surface of the lower substrate 111. That is to say, the first electrets 101 whose size is the same as the first electrodes 102 arranged at the equal intervals P between the center lines of the first electrodes 102. Note that the width of the first electret 101 may be different from that of the first electrode 102. In that case, the first electrets 101 are arranged so that the center lines of the first electrets 101 are overlapped with the center lines of the first electrodes 102 at the same intervals P between the center lines.

The second electrets 103 and the second electrodes 104A may be arranged similarly to the first electrets 101 and the first electrodes 102. The second electrets 103 are arranged on a surface of the movable substrate 110 on the side of the upper substrate 109, and the second electrodes 104A are arranged on a lower surface of the upper substrate 110. Further, the number of the second electrets 103 and the second electrodes 104A may be smaller than the number of the first electrets 101 and the first electrodes 102. In that case, the second electrets 103 and the second electrodes 104A may be arranged at a center line interval different from the center line interval P.

Note that, it is advantageous that the second electrets 103 are arranged so that center lines of the second electrets 103 match with center lines of the second electrodes 104A when the movable substrate 110 is viewed from the vertical direction. However, the positions of the second electrets 103 may be shifted by 10% or less of the width of the second electrodes 104A. That is to say, in this example, the shift is 10 μm or less that is 10% or less of 100 μm. The second electrodes 104A and the second electrets 103 may be relatively shifted within this range according to machining accuracy of manufacturing.

### 7-2. Operation

### 7-2-1. Power Generating Operation of Power Generating Device

Again with reference to FIGS. 15A and 15B, the power generating operation of the power generating device 100f will be described. In the power generating device 100f, the movable substrate 110 follows a force received from an external environment (for example, vibration) to vibrate. A spring constant and a resonance frequency of the elastic structures 112 are optimized so that a maximum vibration is generated with respect to a vibration frequency of an assumed external environment (for example, a vibration at a time of running of an automobile).

In vibration, the movable substrate 110 repeats a state that opposed areas of the first electret 101 and the first electrode 102 are maximum as shown in FIG. 15A and a state that the opposed areas of the first electret 101 and the first electrode 102 are small as shown in FIG. 15B.

Since the lines of electric force of the first electrets 101 direct from the movable substrate 110 towards the lower substrate 111, as the opposed areas of the first electrets 101 and the first electrodes 102 is larger, electric charges attracted to the first electrodes 102 increase (power feeding). On the contrary, as the opposed areas are smaller, the electric charges attracted to the first electrodes 102 decrease more, namely, the electric charges to be released increase more (electric discharge). That is to say, as the opposed areas of the first electrets 101 and the first electrodes 102 are larger, a capacitance value between the first electrodes 102 and the first electrets 101 is larger. As the opposed areas are smaller, the capacitance value is smaller.

When the opposed areas of the first electrets 101 and the first electrodes 102 is larger and accordingly electric charges are attracted to the first electrodes 102, an electric current flows from the first pad 105 to the AC/DC converting circuit 210a for supplying power. On the other hand, when the electric charges attracted to the first electrodes 102 are released by the decrease in the opposed areas, an electric current flows from the AC/DC converting circuit 210a for supplying power to the first pad 105. Further, much the same is true on the second electrets 103 and the second electrodes 104A, an electric current goes in and out between the second electrodes 104A and the AC/DC converting circuit 210b for control via a second pad 113A according to the vibration of the movable substrate 110. The AC power is generated by such an operation of the power generating device 100f.

At this time, the levels of the AC powers output from the first pad 105 and the second pad 113A are different from each other, but their fluctuation transitions are the same as each other. That is to say, when the AC power from the first pad 105 increases, the AC power from the second pad 113A increases. The similar situation is caused at time of decrease. The respective AC powers fluctuate synchronously. Note that, when the first electrets 101 and the second electrets 103 are provided so that their lines of electric forces are directed to the same direction, the directions of the electric currents output from the first pad 105 and the second pad 113A are opposite to each other, but their transitions of the fluctuation of the AC powers are the same as each other.

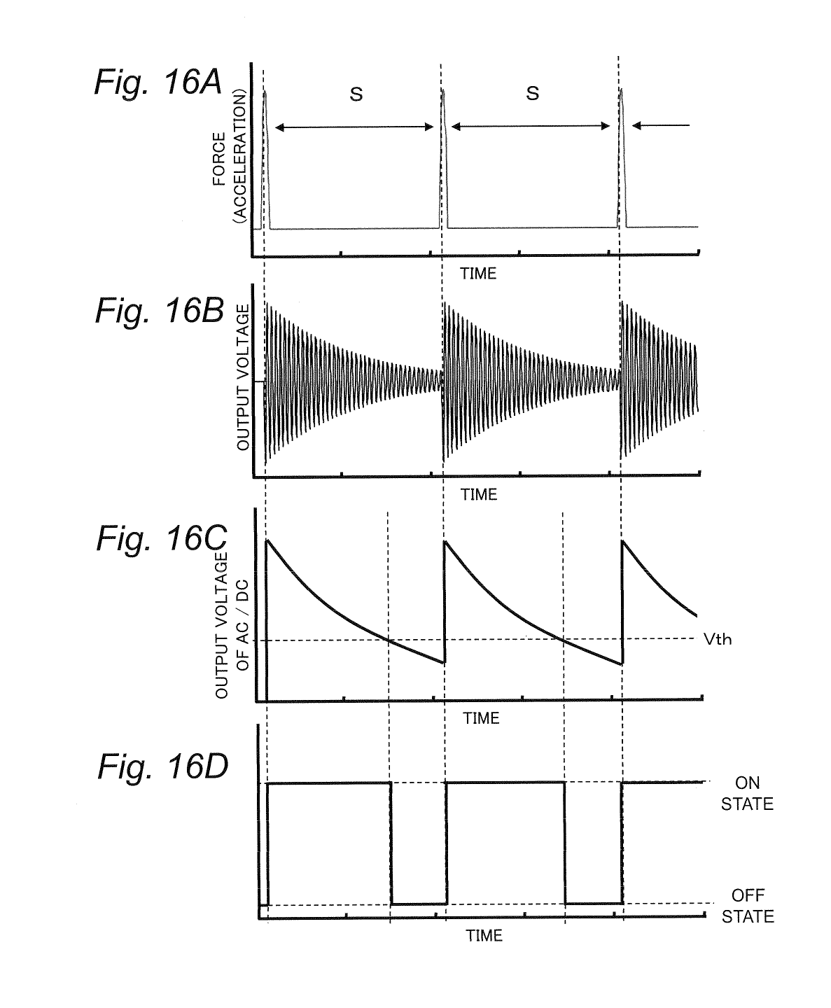

Next, a relationship between the vibration due to the external environment and the power generation of the power generating device 100f will be described. The vibration environment where the power generating device 100f is used includes a vibration environment where constant vibration is continuously generated and a vibration environment where a single impact is generated. In an example shown in FIGS. 16A to 16D, a single impact is applied to the power generating device 100f.

FIG. 16A illustrates a time change in a force (acceleration) applied to the power generating device 100f from the external environment. FIG. 16B illustrates a time change in the output voltage of the power generating device 100f according to the applied force. FIGS. 16C and 16D are described later. When a single impact is applied to the power generating device 100f (FIG. 16A), the movable substrate 110 of the power generating device 100f freely vibrates and the vibration is attenuated with time. The output from the power generating device 100f is attenuated according to the attenuated vibration (FIG. 16B).

### 7-2-2. Operation of Power Management Circuit

### (1) At Time of Normal Power Generation

The lower limit value of voltage in the power supply circuit 221 of the DC/DC converting circuit 220f will be described. As described above, the lower limit value of voltage corresponds to the lower limit value of the driving voltage of the DC/DC converting circuit 220f. Further, the alternate power output from the power generating device 100f via the first pad 105 is proportional to the alternate power output via the second pad 113A. Further, voltages whose level is proportional to the level of the AC powers input into the AC/DC converting circuits 210a and 210b for supplying power and control are output from the AC/DC converting circuits 210a and 210b, respectively. Then, the power conversion efficiency of the DC/DC converting circuit 220f fluctuates based on the level of the output voltage from the AC/DC converting circuit 210a for supplying power. Therefore, for example, the output voltage of the AC/DC converting circuit 210b for control can be calculated in advance where the output power of the DC/DC converting circuit 220f is equal to the power consumption of the DC/DC converting circuit 220f. The second electrodes 104A and the second electrets 103 of the power generating device 100f are configured and arranged so that the output voltage of the AC/DC converting circuit 210b for control is the lower limit value of voltage when, for example, the output voltage of the AC/DC converting circuit 210a for supplying power is the voltage calculated in advance. The lower limit value of voltage is, for example, 3 V that is the driving voltage of the DC/DC converting circuit 220f.

Further, the lower limit value of voltage may be set to correspond to 1/10 of a maximum value of the input power into the DC/DC converting circuit 220f capable of being generated during normal power generation of the power generating device 100f. For example, a case where the maximum value of the input into the normal DC/DC converting circuit 220f is 100 μW will be assumed. When the input power into the DC/DC converting circuit 220f is decreased from 100 μW to 10 μW and thus the power conversion efficiency of the DC/DC converting circuit 220f is, for example, decreased from 85 to 70%, the respective sections are configured so that the output voltage from the AC/DC converting circuit 210 for control is the lower limit value of voltage.

The operation of the power management circuit 200f of when the power generating device 100f outputs the AC power is described with reference to FIGS. 16A to 16D. FIG. 16C illustrates a time change in the output voltage from the AC/DC converting circuit 210b. Vth indicates the lower limit value of voltage. FIG. 16D illustrates the ON/OFF state of the voltage converting operation in the DC/DC converting circuit 220f.

The AC/DC converting circuit 210b for control converts the AC voltage (FIG. 16B) output by the power generating device 100f via the second pad 113A into a DC voltage to output the converted DC voltage to the power supply circuit 221 of the DC/DC converting circuit 220f. The level of the voltage at the output end of the AC/DC converting circuit 210b for control is proportional to the level of the AC power before conversion (FIG. 16C). When the output voltage of the AC/DC converting circuit 210b for control exceeds the lower limit value of voltage, the DC/DC converting circuit 220f performs the power converting operation (“the ON state” in FIG. 16D).

The AC/DC converting circuit 210a for supplying power converts the AC power output by the power generating device 100f via the first pad 105 into a DC power, and outputs the converted DC power to the DC/DC converting circuit 220f. While a voltage that exceeds the lower limit value of voltage is applied to the power supply circuit 221 of the DC/DC converting circuit 220f, the DC/DC converting circuit 220f converts the output power from the AC/DC converting circuit 210a for supplying power into a power of another voltage to supply the converted power to the storage battery at the subsequent stage.

(2) At Time when Vibration (Generated Power) is Too Weak

On the other hand, the generated power from the power generating device 100f is occasionally decreased. For example, as shown in FIG. 16A, a case where a single impact is applied to the power generating device 100f at ever constant period S will be considered. Time for which the power output from the power management circuit 200f is not more than the power consumption of the power management circuit 200f is 30% of the period S in this example (FIG. 16C). That is to say, in the period S, 30% of the power consumed by the power converting operation of the power management circuit 200f does not contribute to the improvement of the generating efficiency. In some cases, in the latter 30% of the period S, the power that is equal to or exceeds the power output from the power management circuit 200f is consumed by the power management circuit 200f. As a result, the generating efficiency of the power generator 1000f is decreased.

Therefore, in the present embodiment, when the input power to the DC/DC converting circuit 220f is not more than 1/10 of the maximum value during the normal time (or the output power of the power management circuit 200f is not more than the power consumption of the power management circuit 200f), an input voltage into the power supply circuit 221 of the DC/DC converting circuit 220f is not more than the lower limit value of voltage, and thus, the DC/DC converting circuit 220f is not driven, and the voltage converting operation is passively suspended.

As described above, the power generator 1000f according to the present embodiment includes the power generating device 100f that generates a power by receiving vibration, and the power converter (power management circuit) 200f that converts the output from the power generating device 100f. The power generating device 100f outputs the powers through the first electrodes 102 and the second electrodes 104A. The power management circuit 200f is driven by receiving the output from the second electrodes 104A of the power generating device 100f, and converts the output from the second electrodes 102 of the power generating device into another power.

With this configuration, in the power generator 1000f according to the present embodiment, when the vibration is attenuated and thus the generated output is decreased, the DC/DC converting circuit 220f of the power management circuit 200f is passively suspended due to the decrease in a driving power. As a result, the entire generating efficiency of the power generator 1000f can be improved. Further, since an additional circuit for controlling the DC/DC converting circuit 220f is not necessary, an increase in the circuit scale can be maintained to the minimum in comparison with the power generator that requires the additional control circuit of the DC/DC converting circuit 220f.

### 8. Seventh Embodiment

A seventh embodiment will be described below.

### 8-1. Configuration and Operation

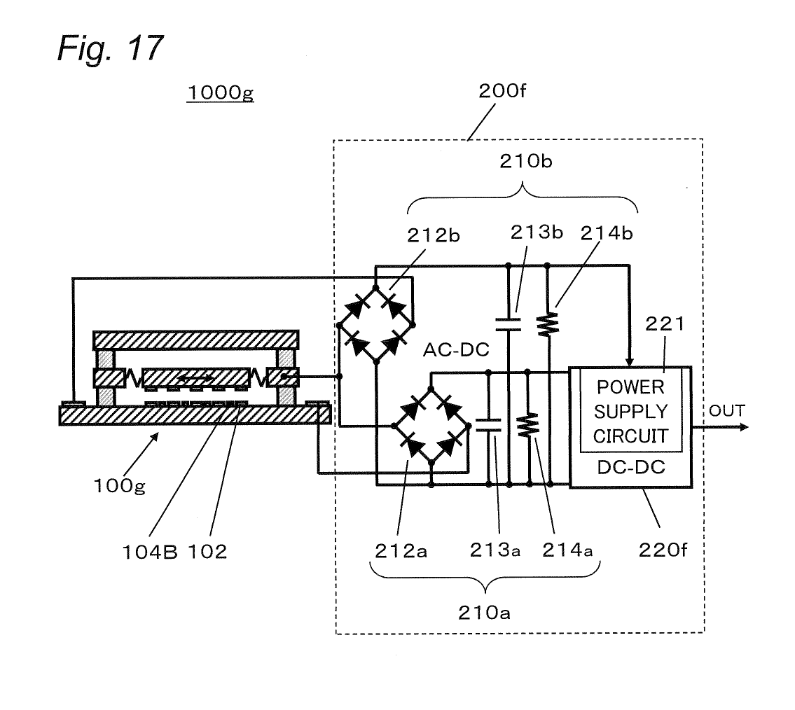

The present embodiment has a configuration shown in FIG. 17. A power generating device 100g according to the present embodiment is different from the power generating device 100f according to the sixth embodiment in arrangements of second electrodes 104B, a second pad 113B, and the second electrets 103. The other parts of the configuration may be similar to that in the sixth embodiment.

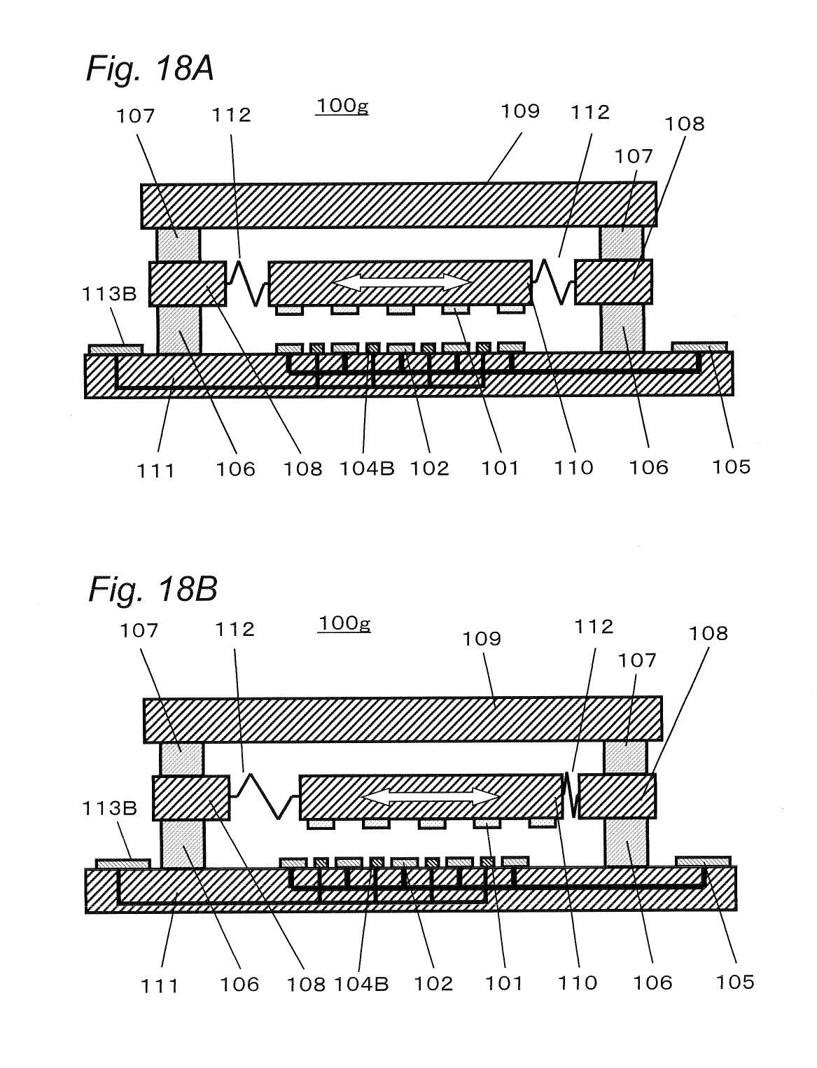

A configuration of the power generating device 100g according to the present embodiment is described with reference to FIGS. 18A and 18B. In the power generating device 100g, the plurality of second electrodes 104B is provided to the upper surface of the lower substrate 111 between the plurality of the first electrodes 102. The first electrodes 102 and the second electrodes 104B are electrically insulated from each other. The adjacent first electrodes 102 are arranged at equal intervals by providing the gap between center lines P. Further, the adjacent second electrodes 104B are also arranged at equal intervals by providing the gap between center lines P. Wiring for connecting the second electrodes 104B passes through the lower substrate ill to be connected to the second pad 113B.

FIG. 18A illustrates a state that the movable substrate 110 is at the center of vibration. In this state, the opposed areas between the first electrets 101 and the first electrodes 102 is maximum, and the opposed areas between the first electrets 101 and the second electrodes 104B is minimum. FIG. 18B illustrates a state that the movable substrate 110 shifts from the center of vibration, and the opposed areas between the first electrets 101 and the first electrodes 102 is minimum and the opposed areas between the first electrets 101 and the second electrodes 104B is maximum. The movable substrate 110 vibrates, and thus repeats the state shown in FIG. 18A, and the state shown in FIG. 18B alternately.

When the opposed areas between the first electrets 101 and the first electrodes 102 is maximum (FIG. 18A), similarly to the sixth embodiment, electric charges are attracted to the first electrodes 102, and thus an electric current flows from the first electrodes 102 to the AC/DC converting circuit 210a for supplying power via the first pad 105. Simultaneously, the electric charges attracted to the second electrodes 104B are released, and thus an electric current flows from the AC/DC converting circuit 210b for control to the second electrodes 104B via the second pad 113B.

On the other hand, when the opposed areas between the first electrets 101 and the second electrodes 104B is maximum, electric charges are attracted to the second electrode 104B, and thus an electric current flows from the second electrodes 104B to the AC/DC converting circuit 210b for control via the second pad 113B. Simultaneously, since the electric charges attracted to the first electrode 102 are released, the electric current flows from the AC/DC converting circuit 210a for supplying power to the first electrode 102 via the first pad 105. With such operations, the power generating device 100g outputs AC power to the AC/DC converting circuit 210a for supplying power and the AC/DC converting circuit 210b for control individually.

Phases of alternating currents output to the AC/DC converting circuit 210a for supplying power and the AC/DC converting circuit 210b for control, respectively, are opposite to each other, but it is not related to control of the DC/DC converting circuit 220f. Also in the present embodiment, similarly to the sixth embodiment, the DC/DC converting circuit 220f can be switched between execution and suspension.

Note that, in the present embodiment, the upper substrate 109 and the lower substrate ill are discriminated by name. However, these names are expediency, and thus their positions may be switched. The first pad 105 is disposed on the substrate provided with the first electrodes 102, and the second pad is disposed on the substrate provided with the second electrodes 104A and 104B.

Note that the above embodiment has one power generating device. However, a configuration where two power generating devices are disposed might be considered. One output is input into the AC/DC converting circuit 210a for supplying power, and the other output is input into the AC/DC converting circuit 210b for control. However, in the configuration where two power generating devices are disposed together, the transitions of the fluctuations in the AC power for supplying power and the AC power for control are not always the same as each other. That is to say, the amplitude of the AC power for supplying power increases, but the amplitude of the AC power for control decreases. The configuration where such a situation is likely to be caused is not mostly suitable for a case where the DC/DC converting circuit 220f is controlled to be switched between execution and suspension based on a generated power from the power generating device. Therefore, like the above embodiment, it is effective to get two types of outputs for supplying power and control from one power generating device.

### 8-2. Conclusion of the Present Embodiment

As described above, a power generator 1000g according to the present embodiment can improve the generating efficiency of the entire power generator 1000g, similarly to the sixth embodiment. Since such an operation can be performed without adding a dedicated control circuit, an increase in the circuit scale can be repressed to the minimum.

### 9. Variants

Variants of particularly the sixth and seventh embodiments in the above-described embodiments will be described below.

In each of the embodiments, when the DC/DC converting circuit 220f is stopped at time of low power generation of the power generating devices 100f or 100g. When the power convertor (the power management circuit) 200f includes a circuit other than the DC/DC converting circuit 220f and a power is consumed by driving of the circuit, the circuit may be stopped. In that case, a value suitable for the driving voltage of the circuit is set as the lower limit value of voltage.

In each of the embodiments, the movable substrate 110 of the power generating devices 100f and 100g is jointed to the upper joints 107 and the lower joints 106 via the springs 112 and the fixed structures 108, and thus is arranged to be separated from the upper substrate 109 and the lower substrate 111. However, the movable substrate 110 may be fixed by another method. Any method may be used as long as the method does not hinder the vibration of the movable substrate 110. For example, the movable substrate 110 may be supported by an electrostatic force or a magnetic force. For example, electrets for supporting the movable substrate 110 are disposed on the upper substrate 109 and the lower substrate 111, and the movable substrate 110 may be fixed by an electrostatic force between the electrets for supporting and the electrets 101 provided onto the movable substrate 110.

Further, in each of embodiments, the movable substrate 110 within the power generating device 100f or 100g vibrates, for example, in a direction indicated by the two-way arrow in FIGS. 15A and 15B. However, this does not exclude a vibration in directions other than the two-way arrow.

Further, by incorporating the power generator 1000f or 1000g according to the above embodiments into electric equipments, electric equipments that can suppress power consumption of a storage battery can be provided.

In the end, eighth to tenth embodiments will be described with reference to the accompanying drawings.

There is a method utilizing an MPPT (Maximum Power Point Tracking) circuit for efficiently outputting a generated power of the power generating device. The MPPT circuit controls the power convertor (the power management circuit) connected between the power generating device and a load so that an output power to the load (the storage battery or the like) at the subsequent stage is maximum. When the MPPT circuit is used in the power generator, the MPPT circuit causes an output power from the power generator to be maximum. However, since a part of the output from the power generating device is input into the MPPT circuit, the generating efficiency of the entire power generator is occasionally deteriorated. Therefore, the eighth to tenth embodiments provide the power generator in which a power loss due to the MPPT circuit is repressed as much as possible and thus the generating efficiency of the entire power generator is improved.

### 10. Eighth Embodiment

### 10-1. Configuration

### 10-1-1. Entire Configuration

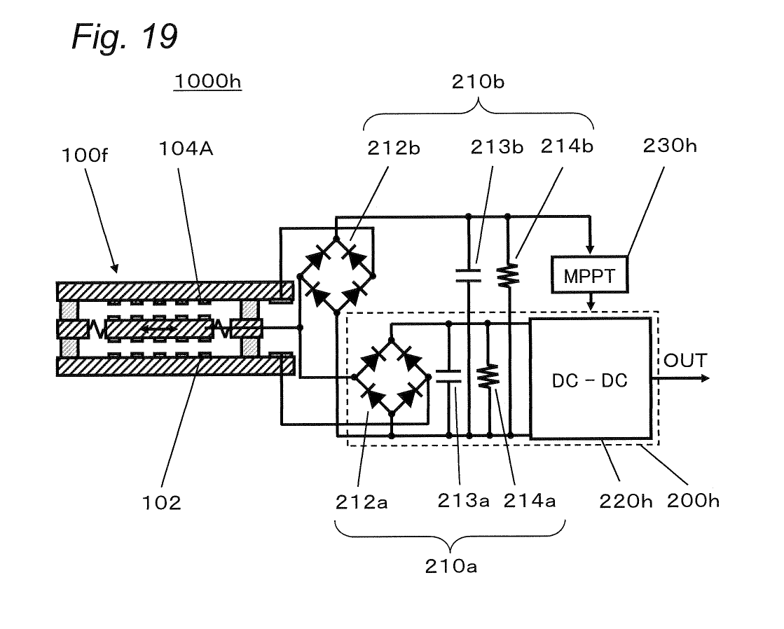

FIG. 19 is a block diagram illustrating the power generator according to the present embodiment. As shown in FIG. 19, a power generator 1000h according to the present embodiment includes a power generating device 100f, and a power convertor (a power management circuit) 200h, an AC/DC converting circuit 210b for control, and an MPPT circuit 230h. The power management circuit 200h includes the AC/DC converting circuit 210a for supplying power and the DC/DC converting circuit 220h. A power generating device 100f is a vibration-type power generating device manufactured by the MEMS (micro electric mechanical) technique. The power generating device 100f includes first electrodes 102 and second electrodes 104A connected to two systems of output, and the like. The AC/DC converting circuit 210a for supplying power and the AC/DC converting circuit 210b for control of the power convertor (the power management circuit) 200h respectively include a smoothing circuit composed of a bridge rectifier circuit 212a (212b) composed of four diodes and a capacitor 213a (213b), and a load resistance 214a (214b).

The power generating device 100f is connected to the AC/DC converting circuit 210a for supplying power by wiring connected to the first electrode 102, and is connected to the AC/DC converting circuit 210b by wiring connected to the second electrode 104A. The AC/DC converting circuit 210a for supplying power is connected to a terminal for inputting a signal of the DC/DC converting circuit 220h. The AC/DC converting circuit 210b for control is connected to the MPPT circuit 230h. The MPPT circuit 230h is connected to the power management circuit 200h. Thereby, the MPPT circuit 230h is connected to a terminal for control of the DC/DC converting circuit 220h. The output of the DC/DC converting circuit 220h, namely, the output of the power converter (power management circuit) 200h is connected to a load (storage battery or the like) at the subsequent stage to supply a power to the load.

The power generating device 100f may have a configuration shown in FIGS. 15A and 15B.

The DC/DC converting circuit 220h converts the DC power output from the AC/DC converting circuit 210a for supplying power into a DC power of another voltage.

The MPPT circuit 230h stores information about output characteristics of the power generating device 100f (for example, voltage-current characteristic). With reference to the information, the MPPT circuit controls the DC/DC converting circuit 220h based on the output from the AC/DC converting circuit 210b for control so that the output power from the DC/DC converting circuit 220h is maximum.

### 10-1-2. Configuration of Power Generating Device

The Configuration of the power generating device 100f is already described with reference to FIGS. 15A and 15B, FIG. 3, and the like. For this reason, the description is omitted.

### 10-2. Operation

### 10-2-1. Generating Operations of Power Generating Device

The generating operations of the power generating device 100f are already described with reference to FIGS. 15A and 15B, and FIGS. 16A to 16D, and the like. For this reason, the description is omitted.

### 10-2-2. Operations of MPPT Circuit

The AC/DC converting circuit 210b for control converts the AC power output via the second pad 113A of the power generating device 100f into a DC power to output the DC power. The MPPT circuit 230h controls the DC/DC converting circuit 220h based on the output from the AC/DC converting circuit 210b for control and information about the voltage-current characteristics of the output from the power generating device 100f so that the output power of the DC/DC converting circuit 220h is maximum (namely, the energy conversion efficiency of the entire power generator is maximum). The MPPT circuit 230h can supply at least a part of the input from the AC/DC converting circuit 210b for control as the driving power of the DC/DC converting circuit 220h to the DC/DC converting circuit 220h. In this case, the DC/DC converting circuit 220h of a power management circuit 200h (the power converter) can be driven by the output from the AC/DC converting circuit 210b for control supplied via the MPPT circuit 230h under the control by the MPPT circuit 230h.

On the other hand, the AC/DC converting circuit 210a for supplying power converts the AC power output via the first pad 105 of the power generating device 100f into a DC power to output the DC power. The DC/DC converting circuit 220h converts the output power of the AC/DC converting circuit 210a for supplying power based on control by the MPPT circuit 230h to output the converted output power to the load (the storage battery or the like) at the subsequent stage.

### 10-3. Conclusion of the Present Embodiment

As described above, the power generator 1000f according to the present embodiment includes the power generating device 100f that generates a power by receiving vibration, the power converter (the power management circuit) 200f that converts the output from the power generating device 100f, and the MPPT circuit that controls the power management circuit 200f. The power generating device outputs the powers through the first electrodes 102 and the second electrodes 104A. The power management circuit 200f converts the output from the first electrodes 102 of the power generating device 100f into another power. The MPPT circuit 230h controls the power management circuit 200f based on the output from the second electrodes 104A of the power generating device 100f.

In such a manner, Since the output for supplying power is separated from the output to be input into the MPPT circuit 230h, a loss of supply power caused by the MPPT circuit 230h can be repressed. As a result, the generating efficiency of an entire power generator 1000h can be further heightened.

### 11. Ninth Embodiment

A ninth embodiment will be described below.

### 11-1. Configuration and Operation

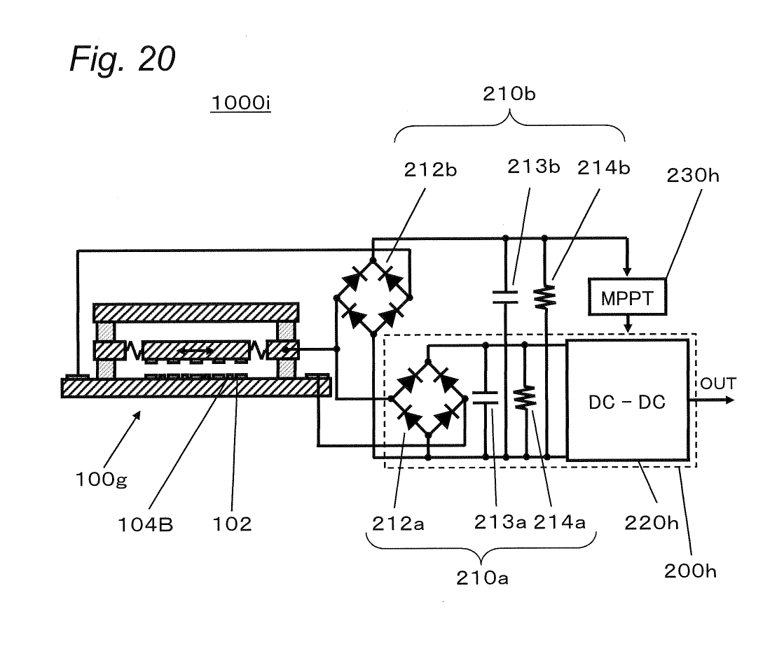

The present embodiment has a configuration shown in FIG. 20. A power generating device 100g according to the present embodiment is different from the power generating device 100f according to the eighth embodiment in arrangements of second electrodes 104B, a second pad 113B, and the second electrets 103. The other parts of the configuration may be similar to that in the eighth embodiment.

The power generating device 100g may have a configuration shown in FIGS. 18A and 18B. A configuration and generating operations of the power generating device 100g are already described with reference to FIGS. 18A and 18B, and the like. For this reason, the description is omitted.

The operations of the MPPT circuit may be similar to the operations in the eighth embodiment.

Note that, in the embodiments, phases of alternating currents to be output to the AC/DC converting circuit 210a for supplying power and the AC/DC converting circuit 210b for control are opposite to each other, but the output power from the DC/DC converting circuit 220h can be maximized (namely, the energy conversion efficiency of the entire power generator can be maximized) also by the AC powers of the alternating currents.

### 11-2. Conclusion of the Present Embodiment

In the power generator 1000i according to the present embodiment, similarly to the eighth embodiment, the output for supplying power is separated from the output to be input into the MPPT circuit 230h, and thus the loss of the supply power due to the MPPT circuit 230h can be repressed. As a result, the generating efficiency of the entire power generator 1000i can be heightened.

### 12. Tenth Embodiment

A tenth embodiment will be described below.

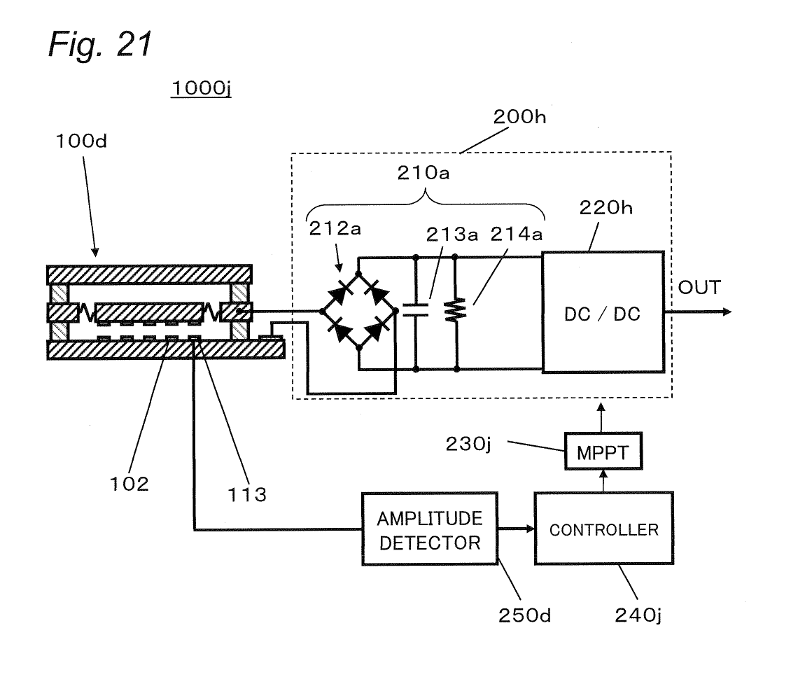

The present embodiment has a configuration shown in FIG. 21. In comparison with the power generating device 100f according to the eighth embodiment, the power generating device 100d according to the present embodiment is provided with the amplitude detection electrode 113 instead of the second electrets 103, the second electrodes 104B and the second pad 113B. Further, instead of the AC/DC converting circuit 210b for control according to the eighth embodiment, the amplitude detector 250d and a controller 240j are provided. The other parts of the configuration may be similar to that in the eighth embodiment.

### 12-1. Configuration and Operations of Power Generating Device

The power generating device 100d may have a configuration shown in FIGS. 12A and 12B. A configuration and generating operations of the power generating device 100g are already described. For this reason, the description is omitted.

The wiring extracted from the amplitude detection electrode 113 is electrically insulated from the wiring to the AC/DC converting circuit 210a for supplying power and is connected to the amplitude detector 250d. The amplitude detector 250d is connected to the controller 240j. The controller 240j is connected to the MPPT circuit 230j, and the MPPT circuit 230j is connected to the power convertor (the power management circuit) 200h through a route different from the AC/DC converting circuit 210a for supplying power. As a result, the MPPT circuit 230j and a control terminal of the DC/DC converting circuit 220h are connected to each other.

Similarly to the eighth embodiment, the power generating device 100d according to the present embodiment generates a power and outputs the power, the AC/DC converting circuit 210a for supplying power and the DC/DC converting circuit 220h convert the power, and the DC/DC converting circuit 220h supplies the power to the load (the storage battery or the like) at the subsequent stage. The MPPT circuit 230j controls the DC/DC converting circuit 220h so that the output power of the DC/DC converting circuit 220h is maximum (namely, the energy conversion efficiency of the entire power generator 1000j is maximum).

At this time, the amplitude detection electrode 113 provided to the power generating device 100d outputs an AC power (voltage) similarly to the output of the AC power (voltage) from the first electrodes 102. The transition of the fluctuation in the AC power output from the amplitude detection electrode 113 is well related to the transition of vibrational amplitude of the movable substrate 110 of the power generating device 100d.

The amplitude detector 250d detects the vibrational amplitude of the movable substrate 110 based on the alternating current output from the power generating device 100d via the amplitude detection electrode 113. The amplitude detector 250d inputs amplitude information to the controller 240j according to the detected amplitude.

The controller 240j calculates an output of the AC/DC converting circuit 210a for supplying power based on the amplitude information, and inputs the calculation result into the MPPT circuit 230j.

The MPPT circuit 230j controls the DC/DC converting circuit 220h of the power management circuit 200h as described above, based on the calculation result of the controller 240j.

### 12-2. Conclusion of the Present Embodiment

The power generator 1000j according to the present embodiment includes the power generating device 100d that generates a power by receiving vibration, the power convertor (the power management circuit) 200h that converts the output from the power generating device 100a, the amplitude detector 250d that detects the vibrational amplitude of the movable electrode 110 inside the power generating device 100d, and the MPPT circuit 230j that controls the power management circuit 200h. The controller 240j calculates the output from the AC/DC converting circuit 210a based on the amplitude information output from the amplitude detector 250d, and inputs the calculation result into the MPPT circuit 230j. The MPPT circuit 230j controls the power management circuit 200h based on the calculation result.

Further, the internal configuration of the power generating device 100d can be made simpler than those of the power generating devices 100f or 100g.

### 13. Variants

Variants of the above embodiments, particularly the eighth to tenth embodiments will be described below.

In the eighth to tenth embodiments, the MPPT circuits 230h or 230j controls the DC/DC converting circuit 220h so that the output power of the DC/DC converting circuit 220h is maximum. However, when the power converter (the power management circuit) 200h includes a circuit other than the DC/DC converting circuit 220h, the MPPT circuits 230h or 230j controls the circuit, so that the energy conversion efficiency of the entire power generator may be made to be maximum.

Further, in the eighth to tenth embodiments, the movable substrate 110 of the power generating devices 100f, 100g, and 100d is jointed to the upper joints 107 and the lower joints 106 via the springs 112 and the fixed structures 108, and thus is arranged to be separated from the upper substrate 109 and the lower substrate 111. However, the movable substrate 110 may be fixed by another method. Any method may be used as long as the method does not hinder the vibration of the movable substrate 110. For example, the movable substrate 110 may be supported by an electrostatic force or a magnetic force. For example, electrets for supporting the movable substrate 110 are disposed on the upper substrate 109 and the lower substrate 111, and the movable substrate 110 may be fixed by an electrostatic force between the electrets for supporting and the electrets 101 and 103 provided onto the movable substrate 110.

Further, in the eighth to tenth embodiments, the movable substrate 110 of the power generating device 100f, 100g, and 100d vibrates, for example, in a direction indicated by the two-way arrow in FIGS. 15A and 15B. However, this does not exclude a vibration in directions other than the two-way arrow.

Further, when any one of the power generators 1000h, 1000i and 1000j according to the eighth to tenth embodiments where the generating efficiency is improved is incorporated into the electric equipment, the electric equipment that can be used for longer time can be provided.

The first to tenth embodiments disclose the following idea about the power generator.

A power generator including a power generating device that generates a power by receiving vibration, and a power converter (power management circuit) that converts the output from the power generating device, wherein the power generating device outputs powers through a first system and a second system, the power converter is driven by receives the output of the second system from the power generating device, and converts the output of the first system from the power generating device into another power.

With such a configuration, when the generated power of the power generating device is decreased, the power converter is passively stopped by the decrease in a driving power. As a result, the generating efficiency of the entire power generator can be improved.

In the above power generator, the power generating device may include a first substrate, a second substrate, and a movable substrate that is arranged between the first substrate and the second substrate and is movable inside the power generating device. A plurality of first electrodes connected to the first system may be disposed on a surface of one of the first substrate and the second substrate opposed to the movable substrate, a plurality of first electrets may be disposed on a surface of the movable substrate opposed to the first electrodes, a plurality of second electrodes connected to the second system may be disposed on a surface of the other one of the first substrate and the second substrate opposed to the movable substrate, and a plurality of second electrets may be disposed on a surface of the movable substrate opposed to the second electrodes.

In the above power generator, the power generating device may include a first substrate, and a movable substrate that is disposed to be opposed to the first substrate and is movable. A plurality of first electrodes connected to the first system and a plurality of second electrodes connected to the second system may be arranged alternately on a surface of the first substrate opposed to the movable substrate, and a plurality of electrets may be arranged on a surface of the movable substrate opposed to the first and second electrodes.

In the above power generator, the first electrodes and the second electrodes of the power generating device may be insulated from each other, and the power generating device may output powers through the first electrodes and the second electrodes, respectively.

In the above power generator, the power converter may include a DC/DC converting circuit that converts a direct current voltage into another direct current voltage. The DC/DC converting circuit may be driven by receiving the output of the second system from the power generating device.

In the above power generator, the power converter may include an AC/DC converting circuit that converts an alternating current voltage into a direct current voltage, and a DC/DC converting circuit that converts a direct current voltage into another direct current voltage. The DC/DC converting circuit may be driven by receiving the output of the second system from the power generating device.

the above power generator may further include an MPPT circuit that controls the power converter. The power converter may convert the output of the first system from the power generator into another power, and the MPPT circuit may control the power converter based on the output of the second system from the power generator.

In the above power generator, the MPPT circuit may control the power converter so that an output form the power converter is maximum.

In the above power generator, the power generating device may include a first substrate, a second substrate, and a movable substrate that is arranged between the first substrate and the second substrate and is movable inside the power generating device. A plurality of first electrodes connected to the first system may be disposed on a surface of one of the first substrate and the second substrate opposed to the movable substrate, a plurality of first electrets may be disposed on a surface of the movable substrate opposed to the first electrodes, a plurality of second electrodes connected to the second system may be disposed on a surface of the other one of the first substrate and the second substrate opposed to the movable substrate, and a plurality of second electrets may be disposed on a surface of the movable substrate opposed to the second electrodes.

In the above power generator, the power generating device may include a substrate, and a movable substrate that is disposed to be opposed to the substrate and is movable. A plurality of first electrodes connected to the first system and a plurality of second electrodes connected to the second system may be alternately disposed on a surface of the substrate opposed to the movable substrate, and a plurality of electrets may be disposed on a surface of the movable substrate opposed to the first electrodes and the second electrodes.

In the above power generator, the first electrodes and the second electrodes of the power generating device may be insulated from each other, and the power generating device may output powers through the first electrodes and the second electrodes.

In the above power generator, the power converter may include a DC/DC converting circuit that converts a direct current voltage into another direct current voltage. The DC/DC converting circuit may be controlled by the MPPT circuit.

In the above power generator, the power converter may include an AC/DC converting circuit that converts an alternating current voltage into a direct current voltage, and a DC/DC converting circuit that converts a direct current voltage into another direct current voltage. The DC/DC converting circuit may be controlled by the MPPT circuit.

An electric equipment including the above power generator may be provided.

The first to tenth embodiments further disclose the following idea about the power generator.

A power generator comprising a power generating device that generates a power by receiving vibration, and a power converter that converts the output from the power generating device, wherein presence/non-presence of power conversion in the power converter is switched based on the output from the power generating device.

With this configuration, when the output of the power generating device is excessive, input into the power convertor is blocked, thereby, a failure of the power convertor can be prevented. Further, when the output of the power generating device is too small, the power converting operation of the power convertor is stopped. Thereby, the power can be efficiently supplied.

The above power generator may further include a detector that detects information about the output from the power generating device, and a controller that switches presence/non-presence of power conversion of the power converter. When determining based on the information that the output from the power generator is not more than the power consumption of the power generator, the controller may stop the power conversion of the power converter.

In the above power generator, when determining based on the information that the output from the power generating device is not less than a predetermined value, the controller may block input from the power generating device into the power converter.

In the above power generator, the information detected by the detector may be the output power of the power generating device.

In the above power generator, the power generating device may have a vibration body that can vibrate. The information detected by the detector may be vibrational amplitude of the vibration body.

The above power generator may further include an MPPT circuit that controls the power converter. The MPPT circuit may control the power converter based on the vibrational amplitude of the vibration body detected by the detector.

the above power generator may further include a passive switch. The passive switch may block or permit input from the power generating device to the power converter according to a level of the output power from the power generating device.

In the above power generator, the passive switch may have an input electrode, an output electrode and a movable electrode. The passive switch may switch conduction/non-conduction between the input electrode and the output electrode due to curving of the movable electrode according to a voltage of the power input into the input electrode.

the above power generator may further include a switch. The controller may control the switch based on the information to block or to permit input of a power from the power generating device into the power converter.

In the above power generator, the power converter may include a DC/DC converter that converts an input direct current voltage into another direct current voltage. The controller may switch presence/non-presence of voltage conversion of the DC/DC converter based on the information.

In the above power generator, the power converter may include an AC/DC converter that converts an alternating current output from the power generating device into a direct current, and a DC/DC converter that converts the direct current output from the AC/DC converter into another direct current voltage. The controller may switch presence/non-presence of voltage conversion of the DC/DC converter based on the information.

An electric equipment may include any one of the above power generators.

### DESCRIPTION OF REFERENCE SIGNS

1000: power generator
100: power generating device
101: (first) electret
102: (first) electrode
103: second electret
104: second electrode
105: (first) pad
106: lower joint
107: upper joint
108: fixed structure
109: upper substrate (second substrate)
110: movable substrate (movable section, weight, or vibration body)
111: lower substrate (first substrate)
112: spring (elastic structure)
113: amplitude detection electrode
113A and 113B: second pad
200: power management circuit
210: AC/DC converting circuit
210a: AC/DC converting circuit for supplying power
210b: AC/DC converting circuit for control
220: DC/DC converting circuit
230: power detector
230h and 230j: MPPT circuit
240: controller
250: amplitude detector
300: switch
310: passive switch
900: load (storage battery)

1-13. (canceled)

14. A power generator comprising:
a power generating device that generates a power by receiving vibration;
a power converter that converts the output from the power generating device;
a detector that detects information about the output from the power generating device; and
a controller that switches presence/non-presence of power conversion of the power converter, wherein
presence/non-presence of power conversion in the power converter is switched based on the output from the power generating device,
when determining based on the information that the output from the power generator is not more than the power consumption of the power generator, the controller stops the power conversion of the power converter.

15. (canceled)

16. The power generator according to claim 14, wherein
when determining based on the information that the output from the power generating device is not less than a predetermined value, the controller blocks input from the power generating device into the power converter.

17. The power generator according to claim 14, wherein
the information detected by the detector is the output power of the power generating device.

18. The power generator according to claim 14, wherein
the power generating device has a vibration body that can vibrate, and
the information detected by the detector is vibrational amplitude of the vibration body.

19. The power generator according to claim 18, further comprising:
an MPPT circuit that controls the power converter, wherein
the MPPT circuit controls the power converter based on the vibrational amplitude of the vibration body detected by the detector.

20. The power generator according to claim 14, further comprising:
a passive switch, wherein
the passive switch blocks or permits input from the power generating device to the power converter according to a level of the output power from the power generating device.

21. The power generator according to claim 20, wherein
the passive switch has an input electrode, an output electrode and a movable electrode, and the passive switch switches conduction/non-conduction between the input electrode and the output electrode due to curving of the movable electrode according to a voltage of the power input into the input electrode.

22. The power generator according to claim 14, further comprising a switch, wherein
the controller controls the switch based on the information to block or to permit input of a power from the power generating device into the power converter.

23. The power generator according to claim 14, wherein
the power converter includes
a DC/DC converter that converts an input direct current voltage into another direct current voltage, and
the controller switches presence/non-presence of voltage conversion of the DC/DC converter based on the information.

24. The power generator according to claim 14, wherein
the power converter includes;
an AC/DC converter that converts an alternating current output from the power generating device into a direct current, and
a DC/DC converter that converts the direct current output from the AC/DC converter into another direct current voltage, and
the controller switches presence/non-presence of voltage conversion of the DC/DC converter based on the information.

25. An electric equipment comprising
the power generator according to claim 14.
